(19) United States
(12) Patent Application Publication
(10) Pub. No.: US 2025/0199590 A1
(43) Pub. Date: Jun. 19, 2025

(54) Methods and Systems for Configuring a Speaker in an Electronic Device Having a Translating Flexible Display

(71) Applicant: Motorola Mobility LLC, Chicago, IL (US)

(72) Inventor: Giles T Davis, Downers Grove, IL (US)

(21) Appl. No.: 18/542,083

(22) Filed: Dec. 15, 2023

(51) Int. Cl. G06F 1/16

(52) U.S. Cl. CPC G06F 1/1688; G06F 1/1624; G06F 1/1652

(57) ABSTRACT

An electronic device includes a device housing, a blade assembly carrying a blade and a flexible display and slidably coupled to the device housing, and a translation mechanism operable to slide the blade assembly relative to the device housing between an extended position and a retracted position. The electronic device includes a first audio output device component mechanically coupled to the blade assembly and a second audio output device component mechanically coupled to a surface carried by the device housing. Translation of the blade assembly to the extended position causes the first audio output device component and the second audio output device component to axially align, thereby defining an audio output device.

### BACKGROUND

### Technical Field

This disclosure relates generally to electronic devices, and more particularly to electronic devices having audio output devices.

### Background Art

Portable electronic communication devices, especially smartphones, have become ubiquitous. People all over the world use such devices to stay connected. These devices have been designed in various mechanical configurations. A first configuration, known as a “candy bar,” is generally rectangular in shape, has a rigid form factor, and has a display disposed along a major face of the electronic device. By contrast, a “clamshell” device has a mechanical hinge that allows one housing to pivot relative to the other. A third type of electronic device is a “slider” where two different device housings slide, with one device housing sliding relative to the other.

Some consumers prefer candy bar devices, while others prefer clamshell devices. Still others prefer sliders. The latter two types of devices are convenient in that they are smaller in a closed position than in an open position, thereby fitting more easily in a pocket. While clamshell and slider devices are relatively straight forward mechanically, they can tend to still be bulky when in the closed position due to the fact that two device housings are required. It would thus be desirable to have an improved electronic device that not only provides a compact geometric form factor without sacrificing audio performance but that allows for the use of a larger display surface area as well.

### BRIEF DESCRIPTION OF THE DRAWINGS

FIG. 1 illustrates one explanatory electronic device in accordance with one or more embodiments of the disclosure.

FIG. 2 illustrates one explanatory electronic device having a translating display moved to a first sliding position where portions of the translating display extend distally away from the device housing of the electronic device.

FIG. 3 illustrates the explanatory electronic device of FIG. 2 with the translating display moved to a second sliding position where the translating display wraps around, and abuts, the device housing of the electronic device.

FIG. 4 illustrates the electronic device of FIG. 3 from the rear.

FIG. 5 illustrates the explanatory electronic device of FIG. 2 with the translating display moved to a third sliding position known as the “peek” position that exposes an image capture device positioned under the translating display when the translating display is in the first sliding position or second sliding position.

FIG. 6 illustrates portions of one explanatory display assembly in an exploded view in accordance with one or more embodiments of the disclosure.

FIG. 7 illustrates portions of one explanatory display assembly in an exploded view in accordance with one or more embodiments of the disclosure.

FIG. 8 illustrates one explanatory display assembly in an exploded view in accordance with one or more embodiments of the disclosure.

FIG. 9 illustrates explanatory display components in accordance with one or more embodiments of the disclosure.

FIG. 10 illustrates one explanatory display assembly in an undeformed state.

FIG. 11 illustrates the explanatory display assembly of FIG. 12 in a deformed state.

FIG. 12 illustrates the explanatory display assembly of FIG. 10 in another deformed state with an exploded view of a deformable portion of the display assembly shown in a magnified view.

FIG. 13 illustrates a front elevation view of one explanatory electronic device in accordance with one or more embodiments of the disclosure with the blade assembly in an extended position.

FIG. 14 illustrates a left side elevation view of one explanatory electronic device in accordance with one or more embodiments of the disclosure with the blade assembly in an extended position.

FIG. 15 illustrates a rear elevation view of one explanatory electronic device in accordance with one or more embodiments of the disclosure with the blade assembly in an extended position.

FIG. 16 illustrates a front elevation view of one explanatory electronic device in accordance with one or more embodiments of the disclosure with the blade assembly in a retracted position.

FIG. 17 illustrates a left elevation view of one explanatory electronic device in accordance with one or more embodiments of the disclosure with the blade assembly in a retracted position.

FIG. 18 illustrates a rear elevation view of one explanatory electronic device in accordance with one or more embodiments of the disclosure with the blade assembly in a retracted position.

FIG. 19 illustrates a front elevation view of one explanatory electronic device in accordance with one or more embodiments of the disclosure with the blade assembly in a peek position revealing a front facing image capture device.

FIG. 20 illustrates a rear elevation view of one explanatory electronic device in accordance with one or more embodiments of the disclosure with the blade assembly in a peek position revealing a front facing image capture device.

FIG. 21 illustrates a cross sectional view of an audio output device in accordance with one or more embodiments of the disclosure.

FIG. 22 illustrates magnet configurations for an audio output device in accordance with one or more embodiments of the disclosure.

FIG. 23 illustrates magnet configurations for an audio output device in accordance with one or more embodiments of the disclosure.

FIG. 24 illustrates a top view of an audio output device component in accordance with one or more embodiments of the disclosure.

FIG. 25 illustrates a top view of another audio output device component in accordance with one or more embodiments of the disclosure.

FIG. 26 illustrates one explanatory electronic device with an audio output device configured in accordance with one or more embodiments of the disclosure when a translating flexible display is in a retracted position.

FIG. 27 illustrates the electronic device of FIG. 26 when the translating flexible display is in an extended position.

FIG. 28 illustrates another explanatory electronic device with an audio output device configured in accordance with one or more embodiments of the disclosure when a translating flexible display is in a retracted position.

FIG. 29 illustrates the electronic device of FIG. 28 when the translating flexible display is in an extended position.

FIG. 30 illustrates still another explanatory electronic device with an audio output device configured in accordance with one or more embodiments of the disclosure when a translating flexible display is in a retracted position.

FIG. 31 illustrates the electronic device of FIG. 30 when the translating flexible display is in an extended position.

FIG. 32 illustrates one explanatory method in accordance with one or more embodiments of the disclosure.

FIG. 33 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to translating a flexible display between an extended position and a retracted position in response to user input, and establishing an audio output device using a translating audio output device and a fixed audio output device component that axially align when the flexible display is in the extended position or the retracted position. Any process descriptions or blocks in flow charts should be understood as representing modules, segments, or portions of code that include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, it is expected that one of ordinary skill, notwithstanding possibly significant effort and many design choices motivated by, for example, available time, current technology, and economic considerations, when guided by the concepts and principles disclosed herein will be readily capable of generating methods and devices with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

Relational terms such as first and second, top and bottom, and the like may be used solely to distinguish one entity or action from another entity or action without necessarily requiring or implying any actual such relationship or order between such entities or actions. As used herein, components may be “operatively coupled” when information can be sent between such components, even though there may be one or more intermediate or intervening components between, or along the connection path.

The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent. The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

Embodiments of the disclosure provide an electronic device that includes a single device housing. In one or more embodiments, a flexible display is then incorporated into a “blade” assembly that wraps around this single device housing. In one or more embodiments, the blade assembly does this by coupling to a translation mechanism attached to the single device housing.

The translation mechanism is operable to transition the blade assembly around the surfaces of the device housing between an extended position where a blade of the blade assembly extends distally from the device housing, a retracted position where the blade assembly abuts the device housing with the flexible display wrapping around the surfaces of the device housing, a “peek” position where movement of the translation mechanism causes the blade assembly to reveal an image capture device situated beneath the blade assembly on the front of the single device housing, and positions in between.

Illustrating by example, in one explanatory embodiment, the blade assembly slides around the single device housing such that the blade slides away from the single device housing to change an overall length of the flexible display appearing on the front of the electronic device. In other embodiments, the blade assembly can slide in an opposite direction around the single device housing to a retracted position with similar amounts of the flexible display visible on the front side of the electronic device and the rear side of the electronic device.

Accordingly, in one or more embodiments an electronic device includes a single device housing with a blade assembly coupled to two major surfaces of the single device housing and wrapping around at least one minor surface of the electronic device where the translation mechanism is positioned such that the blade assembly can slide around, and relative to, the single device housing between a retracted position, an extended position, and a peek position revealing a front-facing image capture device.

In one or more embodiments, the flexible display is coupled to the blade assembly. In one or more embodiments, the flexible display is also surrounded by a silicone border that is co-molded onto a blade substrate and that protects the side edges of the flexible display. In one or more embodiments, the blade assembly engages at least one rotor of the translation mechanism that is situated at an end of the single device housing. When a translation mechanism situated in the single device housing drives elements coupled to the blade assembly, the flexible display wraps around the rotor and moves to extend the blade of the blade assembly further from, or back toward, the single device housing.

In one or more embodiments, one end of the flexible display is fixedly coupled to the blade assembly. Meanwhile, the other end of the flexible display is coupled to the tensioner via a flexible substrate that extends beyond the terminal edges of the flexible display. In one or more embodiments, this flexible substrate is a stainless-steel substrate, although other materials can be used.

Illustrating by example, in one or more embodiments the flexible substrate of the flexible display is longer along its major axis than is the flexible display in at least one dimension. Accordingly, at least a first end of the flexible substrate extends distally beyond at least one terminal end of the flexible display. This allows the first end of the flexible substrate to be rigidly coupled to a tensioner. In one or more embodiments, adhesive is used to couple one end of the flexible display to the blade assembly, while one or more fasteners are used to couple the second end of the flexible display to the tensioner, which is carried by the blade assembly.

In one or more embodiments, the translation mechanism comprises an actuator that causes a portion of the blade assembly abutting a first major surface of the single device housing and another portion of the blade assembly abutting a second major surface of the single device housing to slide symmetrically in opposite directions along the single device housing when the blade assembly transitions between the extended position, the retracted position, and the peek position.

In one or more embodiments, an audio output device operable to deliver acoustic output is formed from two audio output device components. In one or more embodiments, each audio output device component comprises a permanent magnet. Illustrating by example, a first audio output device component can comprise a first permanent magnet while a second audio output device component comprises a second permanent magnet. In one or more embodiments, the first permanent magnet is mechanically coupled to the blade assembly, while the second permanent magnet is mechanically coupled to a surface carried by the device housing.

In one or more embodiments, translation of the blade assembly between the extended position and retracted position causes different audio output device components to axially align, thereby defining an audio output device. Illustrating by example, in one or more embodiments translation of the blade assembly to the extended position causes the first permanent magnet and the second permanent magnet to axially align, thereby defining an audio output device.

When the blade assembly translates to the retracted position, this means that the first permanent magnet and the second permanent magnet will axially misalign. However, when the electronic device comprises a third permanent magnet mechanically coupled to the blade assembly, in one or more embodiments translation of the blade assembly to the retracted position causes the third permanent magnet and the second permanent magnet to align, thereby defining another audio output device.

Thus, when the blade assembly is in the extended position, the first permanent magnet and second permanent magnet define an audio output device with the third permanent magnet being inactive. However, when the blade assembly is in the retracted position, the second permanent magnet and third permanent magnet define an operable audio output device, with the first permanent magnet being inactive. Advantageously, this allows the electronic device to have an operable audio output device that can deliver acoustic output via the blade assembly and flexible display regardless of whether the blade assembly is in the extended position or the retracted position.

In one or more embodiments, a method in an electronic device comprises translating, with a translation mechanism, a blade assembly that is slidably coupled to a device housing and moveable between an extended position and a retracted position to the extended position. In one or more embodiments, when this occurs the extended position axially aligns a first permanent magnet fixedly positioned within the device housing and a second permanent magnet mechanically coupled to the blade assembly to define an audio output device. In one or more embodiments, when a coil coupled to the first permanent magnet is energized with an electrical audio signal, displacement is caused between the first permanent magnet and the second permanent magnet to deliver acoustic energy to an environment of the electronic device.

In one or more embodiments, an electronic device comprises a device housing and a blade assembly carrying a blade and a flexible display that is slidably coupled to the device housing. In one or more embodiments, the electronic device comprises a translation mechanism operable to slide the blade assembly relative to the device housing between an extended position, a retracted position, and a peek position that optionally reveals an image capture device.

In one or more embodiments, the electronic device comprises a first permanent magnet mechanically coupled to the blade assembly and a second permanent magnet mechanically coupled to a surface carried by the device housing such as a circuit board, mechanical support, or other object. In one or more embodiments, translation of the blade assembly to the peek position causes the first permanent magnet and the second permanent magnet to axially align, thereby defining an audio output device.

When the electronic device comprises a third permanent magnet coupled to the blade assembly and a fourth permanent magnet mechanically coupled to the surface, translation of the blade assembly to the retracted position causes the third permanent magnet and first permanent magnet to axially align, thereby defining another audio output device. Advantageously, this allows the electronic device to have an operable audio output device that can deliver acoustic output via the blade assembly and flexible display regardless of whether the blade assembly is in the retracted position or the peek position.

Advantageously, embodiments of the disclosure provide an improved sliding mechanism for a flexible display integrated into a blade assembly in a sliding electronic device having a single device housing that slides in response to user input, and axially aligns permanent magnets when the blade assembly is in one or more predefined positions to define an audio output device operable to deliver acoustic energy to an environment of the electronic device through the blade assembly and flexible display.

The actuator of the translation mechanism can take a variety of forms. In some embodiments, the actuator can comprise a dual-shaft motor. The dual shaft motor can be threaded to move translators of the translation mechanism in equal and opposite directions in one or more embodiments. In other embodiments, the dual-shaft motor can be coupled to at least one timing belt.

In another embodiment, the actuator comprises a first drive screw and a second drive screw. These drive screws can be coupled together by a gear assembly. When a first portion of the blade assembly is coupled to a translator positioned around the first drive screw, and a second portion of the blade assembly is coupled to another translator positioned around the second drive screw, actuation of either causes the first portion of the blade assembly abutting a first major surface of the single device housing and the second portion of the blade assembly abutting a second major surface of the single device housing to move symmetrically in opposite directions as the first drive screw and the second drive screw rotate.

In still other embodiments, the actuator comprises a first rack, a second rack, and a pinion. The first rack can be coupled to the first portion of the blade assembly while the second rack can be coupled to the second portion of the blade assembly. When the pinion engages both the first rack or the second rack, actuation of either causes the first portion of the blade assembly abutting a first major surface of the single device housing and the second portion of the blade assembly abutting a second major surface of the single device housing to move symmetrically in opposite directions as the first rack and second rack do the same. Other configurations of the actuator will be described below. Still others will be obvious to those of ordinary skill in the art having the benefit of this disclosure.

In one or more embodiments, the blade assembly is coupled to the translator of the translation mechanism. When the translator is actuated, a first portion of the blade assembly abutting a first major surface of the single device housing and a second portion of the blade assembly abutting a second major surface of the single device housing move symmetrically in opposite directions.

Advantageously, embodiments of the disclosure provide an improved sliding mechanism for a flexible display in an electronic device. Flexible display and rotor sliding assemblies configured in accordance with embodiments of the disclosure maintain axial alignment between at least one permanent magnet and at least one permanent magnet to ensure that an operable audio output device is available for use at certain positions of the blade assembly while preserving the operability and functionality of the flexible display during sliding operations.

Other advantages will be described below. Still others will be obvious to those of ordinary skill in the art having the benefit of this disclosure.

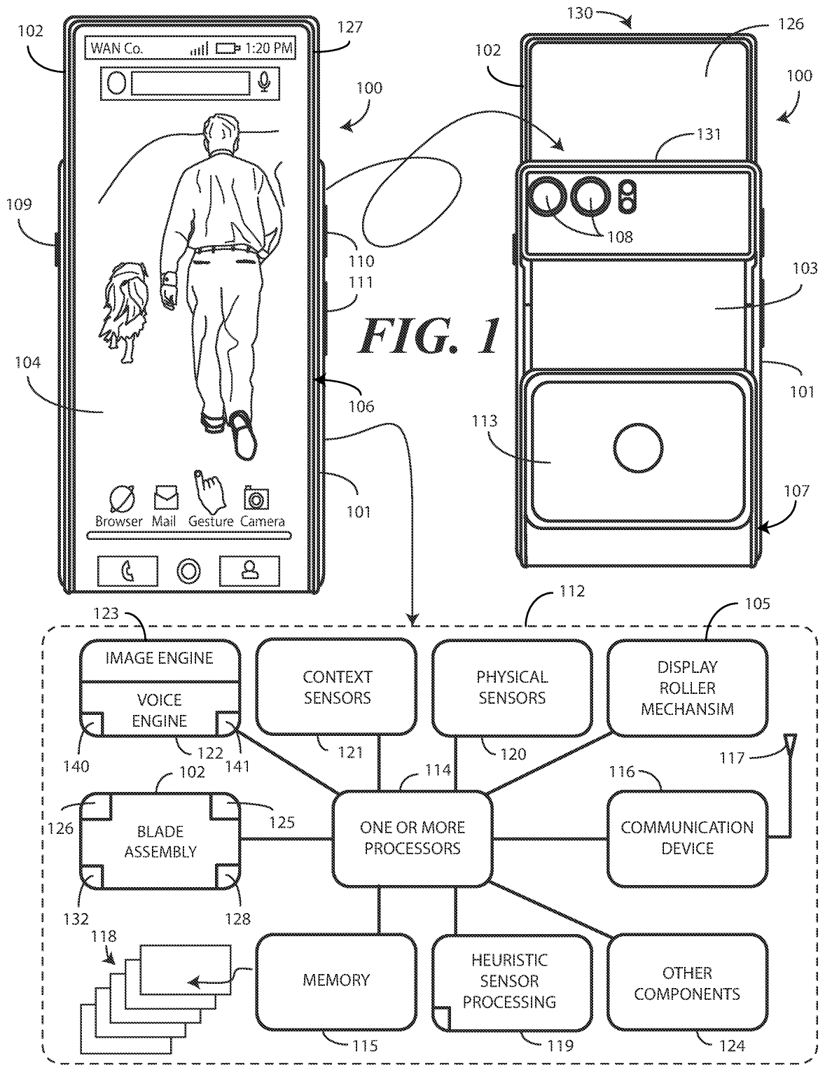

Turning now to FIG. 1, illustrated therein is one explanatory electronic device 100 configured in accordance with one or more embodiments of the disclosure. The electronic device 100 of FIG. 1 is a portable electronic device. For illustrative purposes, the electronic device 100 is shown as a smartphone. However, the electronic device 100 could be any number of other devices as well, including tablet computers, gaming devices, multimedia players, and so forth. Still other types of electronic devices can be configured in accordance with one or more embodiments of the disclosure as will be readily appreciated by those of ordinary skill in the art having the benefit of this disclosure.

The electronic device 100 includes a single device housing 101. In one or more embodiments, a blade assembly 102 carrying a flexible display 104 wraps around the single device housing 101. As will be described in more detail below, in one or more embodiments the blade assembly 102 is configured to “slide” along the first major surface (covered by the flexible display in the front view of the electronic device 100 on the left side of FIG. 1) of the single device housing 101 and second major surface 103 situated on the rear side of the single device housing 101.

In one or more embodiments the single device housing 101 is manufactured from a rigid material such as a rigid thermoplastic, metal, or composite material, although other materials can be used. Illustrating by example, in one illustrative embodiment the single device housing 101 is manufactured from aluminum. Still other constructs will be obvious to those of ordinary skill in the art having the benefit of this disclosure.

In the illustrative embodiment of FIG. 1, the blade assembly 102 carries the flexible display 104. The flexible display 104 can optionally be touch-sensitive. Users can deliver user input to the flexible display 104 of such an embodiment by delivering touch input from a finger, stylus, or other objects disposed proximately with the flexible display 104.

In one embodiment, the flexible display 104 is configured as an organic light emitting diode (OLED) display fabricated on a flexible plastic substrate. The blade assembly 102 is fabricated on a flexible substrate as well. This allows the blade assembly 102 and flexible display 104 to deform around a display roller mechanism 105 when a first portion 106 of the blade assembly 102 abutting a first major surface of the single device housing 101 and a second portion 107 of the blade assembly 102 abutting a second major surface 103 of the single device housing 101 move symmetrically in opposite directions around the single device housing 101. In one or more embodiments, the blade assembly 102 and flexible display 104 are both constructed on flexible metal substrates can allow each to bend with various bending radii around the display roller mechanism 105.

In one or more embodiments the flexible display 104 may be formed from multiple layers of flexible material such as flexible sheets of polymer or other materials. In this illustrative embodiment, the flexible display 104 is fixedly coupled to the blade assembly 102, which wraps around the display roller mechanism 105.

Features can be incorporated into the single device housing 101. Examples of such features include one or more cameras or image capture devices 108 or an optional speaker port. In this illustrative embodiment, user interface components 109,110,111, which may be buttons, fingerprint sensors, or touch sensitive surfaces, can also be disposed along the surfaces of the single device housing 101. Any of these features are shown being disposed on the side surfaces of the electronic device 100 could be located elsewhere. In other embodiments, these features may be omitted.

A block diagram schematic 112 of the electronic device 100 is also shown in FIG. 1. The block diagram schematic 112 includes one or more electronic components that can be coupled to a printed circuit board assembly disposed within the single device housing 101. Alternatively, the electronic components may be carried by the blade assembly 102. Illustrating by example, in one or more embodiments electronic components can be positioned beneath a “backpack” 113 carried by the blade assembly 102.

The components of the block diagram schematic 112 can be electrically coupled together by conductors or a bus disposed along one or more printed circuit boards. For example, some components of the block diagram schematic 112 can be configured as a first electronic circuit fixedly situated within the single device housing 101, while other components of the block diagram schematic 112 can be configured as a second electronic circuit carried by the blade assembly 102 in the backpack 113. A flexible substrate can then extend from the first electronic circuit in the single device housing 101 to the second electronic circuit carried by the blade assembly 102 in the backpack 113 to electrically couple the first electronic circuit to the second electronic circuit.

The illustrative block diagram schematic 112 of FIG. 1 includes many different components. Embodiments of the disclosure contemplate that the number and arrangement of such components can change depending on the particular application. Accordingly, electronic devices configured in accordance with embodiments of the disclosure can include some components that are not shown in FIG. 1, and other components that are shown may not be needed and can therefore be omitted.

In one or more embodiments, the electronic device 100 includes one or more processors 114. In one embodiment, the one or more processors 114 can include an application processor and, optionally, one or more auxiliary processors. One or both of the application processor or the auxiliary processor(s) can include one or more processors. One or both of the application processor or the auxiliary processor(s) can be a microprocessor, a group of processing components, one or more ASICs, programmable logic, or other type of processing device.

The application processor and the auxiliary processor(s) can be operable with the various components of the electronic device 100. Each of the application processor and the auxiliary processor(s) can be configured to process and execute executable software code to perform the various functions of the electronic device 100. A storage device, such as memory 115, can optionally store the executable software code used by the one or more processors 114 during operation.

In one embodiment, the one or more processors 114 are responsible for running the operating system environment of the electronic device 100. The operating system environment can include a kernel and one or more drivers, and an application service layer, and an application layer. The operating system environment can be configured as executable code operating on one or more processors or control circuits of the electronic device 100. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In this illustrative embodiment, the electronic device 100 also includes a communication device 116 that can be configured for wired or wireless communication with one or more other devices or networks. The networks can include a wide area network, a local area network, and/or personal area network. The communication device 116 may also utilize wireless technology for communication, such as, but are not limited to, peer-to-peer or ad hoc communications such as HomeRF, Bluetooth and IEEE 802.11, and other forms of wireless communication such as infrared technology. The communication device 116 can include wireless communication circuitry, one of a receiver, a transmitter, or transceiver, and one or more antennas 117.

In one embodiment, the one or more processors 114 can be responsible for performing the primary functions of the electronic device 100. For example, in one embodiment the one or more processors 114 comprise one or more circuits operable with one or more user interface devices, which can include the flexible display 104, to present, images, video, or other presentation information to a user. The executable software code used by the one or more processors 114 can be configured as one or more modules 118 that are operable with the one or more processors 114. Such modules 118 can store instructions, control algorithms, logic steps, and so forth.

In one embodiment, the one or more processors 114 are responsible for running the operating system environment of the electronic device 100. The operating system environment can include a kernel and one or more drivers, and an application service layer, and an application layer. The operating system environment can be configured as executable code operating on one or more processors or control circuits of the electronic device 100. The application layer can be responsible for executing application service modules. The application service modules may support one or more applications or “apps.” The applications of the application layer can be configured as clients of the application service layer to communicate with services through application program interfaces (APIs), messages, events, or other inter-process communication interfaces. Where auxiliary processors are used, they can be used to execute input/output functions, actuate user feedback devices, and so forth.

In one embodiment, the one or more processors 114 may generate commands or execute control operations based on information received from the various sensors of the electronic device 100. As shown in FIG. 1, these sensors can be categorized into physical sensors 120 and context sensors 121.

Generally speaking, physical sensors 120 include sensors configured to sense or determine physical parameters indicative of conditions in an environment about the electronic device 100. Illustrating by example, the physical sensors 120 can include devices for determining information such as motion, acceleration, orientation, proximity to people and other objects, lighting, capturing images, and so forth. The physical sensors 120 can include various combinations of microphones, location detectors, temperature sensors, barometers, proximity sensor components, proximity detector components, wellness sensors, touch sensors, cameras, audio capture devices, and so forth.

By contrast, the context sensors 121 do not measure physical conditions or parameters. Instead, they infer context from data of the electronic device. Illustrating by example, when a physical sensor 120 includes a camera or intelligent imager, the context sensors 121 can use data captured in images to infer contextual cues. An emotional detector may be operable to analyze data from a captured image to determine an emotional state. The emotional detector may identify facial gestures such as a smile or raised eyebrow to infer a person's silently communicated emotional state, e.g., joy, anger, frustration, and so forth. Other context sensors 121 may analyze other data to infer context, including calendar events, user profiles, device operating states, energy storage within a battery, application data, data from third parties such as web services and social media servers, alarms, time of day, behaviors a user repeats, and other factors.

The context sensors 121 can be configured as either hardware components, or alternatively as combinations of hardware components and software components. The context sensors 121 can be configured to collect and analyze non-physical parametric data.

In one or more embodiments, a heuristic sensor processor 119 can be operable with both the physical sensors 120 and the context sensors 121 to detect, infer, capture, and otherwise determine when multi-modal social cues are occurring in an environment about an electronic device. In one embodiment, the heuristic sensor processor 119 determines, from one or both of the physical sensors 120 or the context sensors 121, assessed contexts and frameworks using adjustable algorithms of context assessment employing information, data, and events. These assessments may be learned through repetitive data analysis. Alternatively, a user may employ the user interface of the electronic device 100 to enter various parameters, constructs, rules, and/or paradigms that instruct or otherwise guide the heuristic sensor processor 119 in detecting multi-modal social cues, emotional states, moods, and other contextual information. The heuristic sensor processor 119 can comprise an artificial neural network or other similar technology in one or more embodiments.

In one or more embodiments, the heuristic sensor processor 119 is operable with the one or more processors 114. In some embodiments, the one or more processors 114 can control the heuristic sensor processor 119. In other embodiments, the heuristic sensor processor 119 can operate independently, delivering information gleaned from detecting multi-modal social cues, emotional states, moods, and other contextual information to the one or more processors 114. The heuristic sensor processor 119 can receive data from one or both of the physical sensors 120 or the context sensors 121. In one or more embodiments, the one or more processors 114 are configured to perform the operations of the heuristic sensor processor 119.

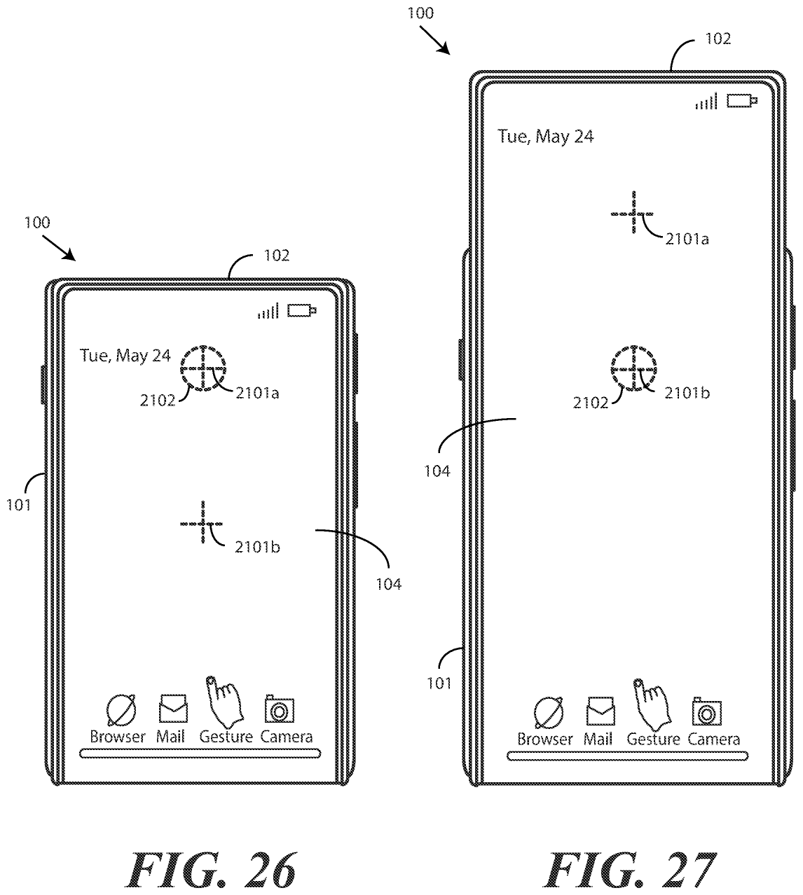

In one or more embodiments, the block diagram schematic 112 includes a voice engine 122. The voice engine 122 comprise one or more audio output devices operable to deliver acoustic energy to an environment of the electronic device 100. As will be described in more detail below with reference to FIGS. 26-31, the voice engine 122 can include hardware, executable code, and a plurality of permanent magnets that, when paired together, define audio output devices operable to deliver acoustic energy to the environment of the electronic device 100.

In one or more embodiments, the voice engine 122 comprises at least two audio output device components 140,141. In one or more embodiments, each audio output device component 140,141 comprises a permanent magnet. Illustrating by example, a first audio output device component 140 can comprise a first permanent magnet while a second audio output device component 141 comprises a second permanent magnet. In one or more embodiments, the first permanent magnet is mechanically coupled to the blade assembly 102, while the second permanent magnet is mechanically coupled to a surface carried by the device housing 101.

In one or more embodiments, translation of the blade assembly 102 between the extended position and retracted position causes different audio output device components 140,141 to axially align, thereby defining an audio output device. Illustrating by example, in one or more embodiments translation of the blade assembly 102 to the extended position causes the first permanent magnet and the second permanent magnet to axially align, thereby defining an audio output device.

When the blade assembly 102 translates to the retracted position, this means that the first permanent magnet and the second permanent magnet will axially misalign. However, when the electronic device 100 comprises a third permanent magnet mechanically coupled to the blade assembly 102, in one or more embodiments translation of the blade assembly 102 to the retracted position causes the third permanent magnet and the second permanent magnet to align, thereby defining another audio output device.

Thus, when the blade assembly 102 is in the extended position, the first permanent magnet and second permanent magnet define an audio output device with the third permanent magnet being inactive. However, when the blade assembly is in the retracted position, the second permanent magnet and third permanent magnet define an operable audio output device, with the first permanent magnet being inactive. Advantageously, this allows the electronic device to have an operable audio output device that can deliver acoustic output via the blade assembly and flexible display regardless of whether the blade assembly is in the extended position or the retracted position.

The block diagram schematic 112 can also include an image/gaze detection-processing engine 123. The image/gaze detection-processing engine 123 can be operable with the physical sensors 120, such as a camera or intelligent imager, to process information to detect a user's gaze point. The image/gaze detection-processing engine 123 can optionally include sensors for detecting the alignment of a user's head in three-dimensional space. Electronic signals can then be delivered from the sensors to the image/gaze detection-processing engine 123 for computing the direction of user's gaze in three-dimensional space. The image/gaze detection-processing engine 123 can further be configured to detect a gaze cone corresponding to the detected gaze direction, which is a field of view within which the user may easily see without diverting their eyes or head from the detected gaze direction. The image/gaze detection-processing engine 123 can be configured to alternately estimate gaze direction by inputting images representing a photograph of a selected area near or around the eyes.

The one or more processors 114 may also generate commands or execute control operations based upon information received from a combination of the physical sensors 120, the context sensors 121, the flexible display 104, the other components 124, and/or the other input devices. Alternatively, the one or more processors 114 can generate commands or execute control operations based upon information received from the one or more sensors or the flexible display 104 alone. Moreover, the one or more processors 114 may process the received information alone or in combination with other data, such as the information stored in the memory 115.

Other components 124 operable with the one or more processors 114 can include output components such as video outputs, audio outputs, and/or mechanical outputs. Examples of output components include audio outputs such as speaker port, earpiece speaker, or other alarms and/or buzzers and/or a mechanical output component such as vibrating or motion-based mechanisms. Still other components will be obvious to those of ordinary skill in the art having the benefit of this disclosure.

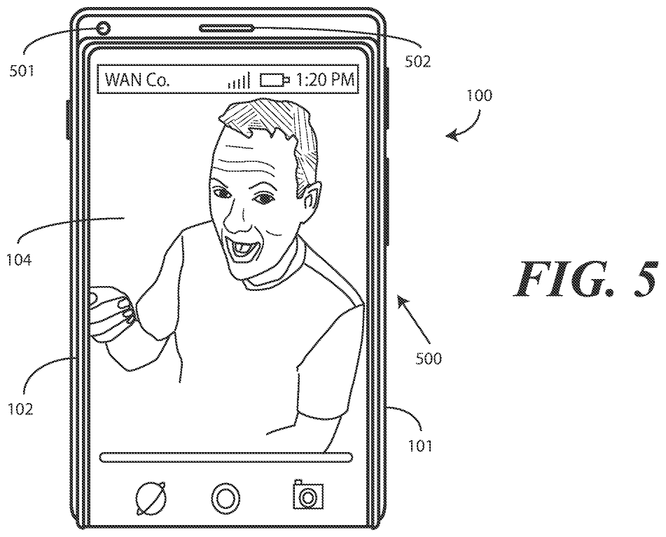

As noted above, in one or more embodiments a blade assembly 102 is coupled to the flexible display 104. In contrast to sliding devices that include multiple device housings, the electronic device 100 of FIG. 1 includes a single device housing 101 to which the blade assembly 102 is coupled. The blade assembly 102 is configured as a mechanical chassis that allows the flexible display 104 to translate along a translation surface defined by major and minor surfaces of the single device housing 101. In one or more embodiments, the blade assembly 102 also provides a mechanical support for portions 130 of the flexible display 104 that extend beyond the top edge 131 of the single device housing 101 when the blade assembly 102 and flexible display 104 are in the extended position shown in FIG. 1. When the display roller mechanism 105 actuates, it causes the blade assembly 102 and the flexible display 104 to translate 301 along the rear major surface 103, the bottom minor surface, and the front major surface between the extended position shown in FIG. 1, the retracted position shown in FIG. 3, and the peek position shown in FIG. 5.

The blade assembly 102 can include a blade substrate 125 that includes both flexible portions and rigid portions, and that is positioned between the flexible display 104 and the translation surface defined by the single device housing 101. The blade substrate 125 can also comprise a silicone border 127 that surrounds and protects the edges of the flexible display 104. In one or more embodiments, the blade substrate 125 comprises a steel backer plate with the silicone border 127 co-molded around the perimeter of the steel backer plate. In one or more embodiments, a low-friction dynamic bending laminate stack 128 and blade 126 are positioned between the blade assembly 102 and the translation surfaces defined by the single device housing 101.

In one or more embodiments, the blade substrate 125 is partially rigid and partially flexible. Illustrating by example, portions of the blade substrate 125 that slide along the major surfaces of the single device housing 101 are configured to be substantially rigid, while portions of the blade substrate 125 that pass around the minor surfaces of the single device housing 101 are configured to be flexible so that they can curl around those minor surfaces. In one or more embodiments, some portions of the blade substrate 125 abut the translation surfaces defined by the single device housing 101 while other portions abut the display roller mechanism 105, which is positioned at the bottom minor surface of the single device housing 101 in this illustrative embodiment.

In one or more embodiments, the blade 126 and the low-friction dynamic bending laminate stack 128 are positioned between the blade assembly 102 and the translation surfaces defined by the single device housing 101. The blade 126 supports portions of the blade assembly 102 and flexible display 104 that extend beyond the top edge 131 of the single device housing 101 when the blade assembly 102 is transitioned to the extended position shown in FIG. 1. Since this blade 126 needs to be rigid to support those portions of the blade assembly 102 and the flexible display 104, it is not able to bend around the display roller mechanism 105. To prevent gaps or steps from occurring where the blade 126 terminates, in one or more embodiments a low-friction dynamic bending laminate stack 128 spans the remainder of the blade assembly 102 and abuts the transition surfaces defined by the single device housing 101.

The blade assembly 102 can be fixedly coupled to the flexible display 104 by an adhesive or other coupling mechanisms. Where the blade substrate 132 defines both rigid and flexible portions. The blade substrate 132 can define a first rigid section extending along the major surfaces of the single device housing 101 and a second flexible section extending configured to wrap around the minor surfaces of the single device housing 101 where the display roller mechanism 105 is positioned.

In one or more embodiments, the blade assembly 102 defines a mechanical assembly providing a slider framework that allows the flexible display 104 to move between the extended position of FIG. 1, the retracted position of FIG. 3, and the peek position of FIG. 5. As used herein, the term “framework” takes the ordinary English definition of a mechanical support structure supporting the other components coupled to the slider framework. These components can include the blade 126, the silicone border 127, and the low-friction dynamic bending laminate stack 128. Other components can be included as well. Illustrating by example, this can include electronic circuits for powering the flexible display 104. In one or more embodiments, it can further include a tensioner that ensures that the flexible display 104 remains flat against the single device housing 101 when translating.

In one or more embodiments, the display roller mechanism 105 that causes a first portion of the blade assembly 102 and the flexible display 104 display (shown on the rear side of the electronic device 100 in FIG. 1) and a second portion of the blade assembly 102 and the flexible display 104 (positioned on the front side of the electronic device 100 in FIG. 1) to slide symmetrically in opposite directions along the translation surfaces defined by the single device housing 101.

Thus, the electronic device 100 of FIG. 1 includes a single device housing 101 with a flexible display 104 incorporated into a blade assembly 102. The blade assembly 102 is then coupled to a translation mechanism defined by the display roller mechanism 105 and situated within the single device housing 101. In the explanatory embodiment of FIG. 1, the display roller mechanism 105 is situated at the bottom edge of the single device housing 101.

In one or more embodiments, in response to the receipt of user input, the translation mechanism defined by the display roller mechanism 105 is operable to transition the blade assembly 102 around the surfaces of the single device housing 101 between the extended position of FIG. 1 where the blade 126 of the blade assembly 102 extends distally from the single device housing 101 and a retracted position (shown in FIG. 3) where the blade assembly 102 abuts the single device housing 101 with the flexible display 104 wrapping around the surfaces of the single device housing 101. The translation mechanism can optionally also translate the blade assembly 102 to a “peek” position (shown in FIG. 5) where movement of the translation mechanism defined by the display roller mechanism 105 causes the blade assembly 102 to reveal an image capture device situated beneath the blade assembly 102 on the front of the single device housing 101.

In other embodiments, translation of the blade assembly 102 can be initiated by the operation of a user interface component 110. Embodiments of the disclosure contemplate that in such an electronic device 100, manual actuation of the user interface component 110 potentially delays the usability of the electronic device 100 in the new state due to the time taken to manually “inject” the trigger causing transition of the blade assembly 102 and flexible display 104 by requiring the actuation of the user interface component 110.

Advantageously, embodiments of the disclosure provide intuitive operation of a translating display in an electronic device 100 that maintains, in certain predefined positions, the ability of an audio output device to leverage the large surface area provided by front-facing portions of the blade assembly and flexible display to deliver acoustic energy to the environment of the electronic device 100.

As shown in FIG. 1, the blade assembly 102 is able to slide around the single device housing 101 such that the blade 126 slides away from the single device housing 101 to change the apparent overall length of the flexible display 104 as viewed from the front of the electronic device 100. By contrast, in other states (such as the one shown in FIG. 3) the blade assembly 102 can slide in an opposite direction around the single device housing 101 to a retracted position with similar amounts of the flexible display 104 visible on the front side of the electronic device 100 and the rear side of the electronic device 100.

In FIG. 1, the electronic device 100 includes a single device housing 101 with a blade assembly 102 coupled to two major surfaces of the single device housing 101 and wrapping around at least one minor surface of the electronic device 100 where the display roller mechanism 105 is situated. This allows the blade assembly 102 to slide relative to the single device housing 101 between a retracted position of FIG. 3, the extended position of FIG. 1, and the peek position of FIG. 5 revealing a front-facing image capture device.

It is to be understood that FIG. 1 is provided for illustrative purposes only and for illustrating components of one electronic device 100 in accordance with embodiments of the disclosure and is not intended to be a complete schematic diagram of the various components required for an electronic device. Therefore, other electronic devices in accordance with embodiments of the disclosure may include various other components not shown in FIG. 1 or may include a combination of two or more components or a division of a particular component into two or more separate components, and still be within the scope of the present disclosure.

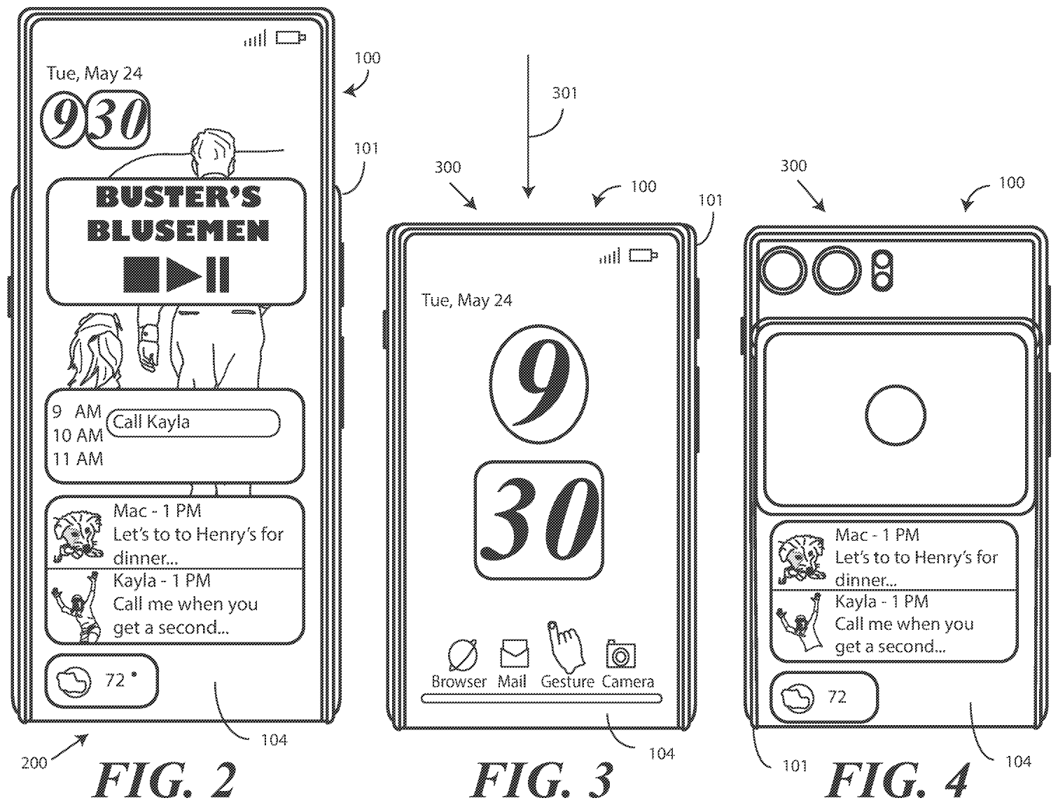

Turning now to FIG. 2, illustrated therein is the electronic device 100 in the extended position 200 that was also shown in FIG. 1. In the extended position 200, the blade (126) slides outward and away from the single device housing 101, thereby revealing more and more portions of the flexible display 104. In such a configuration, the portions of flexible display 104 passing around the display roller mechanism (105) elongated into a flat position as they pass along the translation surface defined by the front of the single device housing 101.

Turning now to FIGS. 3-4, illustrated therein is the electronic device 100 with the flexible display 104 in the retracted position 300. FIG. 3 illustrates the front side of the electronic device 100, while FIG. 4 illustrates the rear side.

In this state, blade (126) slides back toward, and then along, the translation surface defined by the single device housing 101. This causes the apparent overall length of the flexible display 104 to get shorter as more and more portions of the flexible display 104 pass around the display roller mechanism (105) positioned at the bottom of the single device housing 101 and across the translation surface defined by the rear side of the single device housing 101.

Turning now to FIG. 5, illustrated therein is the electronic device 100 with the flexible display in the peek position 500. When in the peek position, the blade assembly 102 and the flexible display 104 translate past the retracted position (300) of FIG. 3. In one or more embodiments, when this occurs, the blade assembly 102 and the flexible display 104 reveal an image capture device 501 that is situated beneath the blade assembly 102 and the flexible display 104 when they are in the retracted position (300) of FIG. 3. In this illustrative embodiment, a loudspeaker 502 is also revealed.

Advantageously, by positioning the image capture device 501 beneath the blade assembly 102 and the flexible display 104 when these components are in either the retracted position (300) of FIGS. 3-4 or the extended position (200) of FIG. 2, a user of the electronic device 100 is assured of privacy due to the fact that the image capture device 501 is not able to see through the blade (126) of the blade assembly 102. Accordingly, even if the electronic device 100 is accessed by a hacker or other nefarious actor, the user can be assured that the image capture device 501 cannot capture images or videos while the blade assembly 102 and flexible display 104 are in the retracted position (300), the extended position (200), or in positions therebetween. Only when the blade assembly 102 and the flexible display 104 transition to the peek position 500, thereby revealing the image capture device 501, can the image capture device 501 capture front-facing images or front-facing videos.

Referring collectively to FIGS. 2-5, one will see that the electronic device 100 includes a single device housing with a flexible display 104 incorporated into a blade assembly 102. The blade assembly 102 is coupled to a translation mechanism situated within the single device housing 101.

In response to actuation of a user interface device, one example of which is a button positioned on a side of the single device housing 101, or alternatively automatically in response to a pinch gesture or zoom gesture delivered to the flexible display 104, a translation mechanism (105) is operable to transition the blade assembly 102 around the surfaces of the single device housing 101 between the extended position 200 where the blade (126) of the blade assembly 102 extends distally from the single device housing 101, the retracted position 300 where the blade assembly 102 abuts the single device housing 101 with the flexible display 104 and blade assembly 102 wrapping around the surfaces of the single device housing 101, optionally the peek position 500 where movement of the translation mechanism causes the blade assembly 102 to reveal the image capture device 501 (and loudspeaker 502 in this example) situated beneath the blade assembly 102 on the front side of the single device housing 101, or even positions therebetween, such as would be the case when the one or more processors (114) of the electronic device 100 are attempting to accommodate a content presentation corresponding to the opening of an application tray on the flexible display 104.

Another feature that can be seen in reviewing FIGS. 2-5 collectively is the how the presentation of content changes as a function of the position of the blade assembly 102. Embodiments of the disclosure contemplate that the position of the blade assembly 102 and flexible display 104 relative to the single device housing 101 change the amount of the flexible display 104 that is visible from the front, visible from the rear, and visible in the curved end portions. Said differently, the viewable size of the flexible display 104 from each side of the electronic device 100 will vary as a function of the position of the blade assembly 102 relative to the single device housing 101. Advantageously, embodiments of the disclosure provide applications, methods, and systems that dynamically resize and adjust the interface layouts and content presentations.

This can be accomplished by resizing a primary visible portion, e.g., the front-facing portion shown in FIGS. 2, 3, and 5, of the flexible display 104. Applications can be windowed on this primary area of the flexible display 104, which will resize as the flexible display 104 as it transitions between the extended position 200 of FIG. 2, the retracted position 300 of FIGS. 3-4, and the peek position 500 of FIG. 5.

In FIGS. 2-5, the one or more processors (114) of the electronic device 100 segment the flexible display 104 into three, individual, usable parts. These include the front-facing portion of the flexible display 104 shown in FIGS. 2, 3, and 5, the rear-facing portion of the flexible display 104 shown in FIG. 5, and the curvilinear portion of the flexible display 104 situated at the bottom of the electronic device 100 and wrapping around the rotor, shown in FIGS. 2-5. This curvilinear portion of the flexible display 104 is sometimes referred to as the “roll edge” portion of the display.

In one or more embodiments, each of these usable parts are dynamically remapped as the flexible display 104 changes position relative to the single device housing 101. In one or more embodiments, applications can request a window on the usable portion upon which it intends to present content.

In one or more embodiments, the orientation of the rear-facing portion and the roll edge portion is not the same as that of the front-facing portion when the flexible display 104 translates along the single device housing 101 from the extended position 200 shown in FIG. 2 to the retracted position 300 shown in FIGS. 3-4 or the peek position 500 of FIG. 5. To address this, as can be seen by comparing FIGS. 3-4, in one or more embodiments content presented on the rear-facing portion is rotated by 180-degrees so that its “up” side is the same as the “up” side on the front-facing portion.

In one or more embodiments, the orientation of content presented on the roll edge portion can change based upon the orientation of the electronic device 100. If, for example, the front-facing side is up the orientation of content presented on the roll edge will have a first orientation. By contrast, if the rear-facing side is up, the orientation of that same content presented on the roll edge will have a second orientation that is rotated 180-degrees relative to the first orientation.

In one or more embodiments, any content presented on the front-facing portion of the flexible display 104 is oriented in accordance with user preferences. In one or more embodiments, this front-facing portion is oriented in accordance with the orientation of the electronic device 100 in three-dimensional space.

On the roll edge portion of the translating display, in one or more embodiments this segment is oriented in the same orientation as the front-facing portion when the electronic device 100 is not oriented with the front-facing side facing the negative z-direction in three-dimensional space (it is rotated by 180-degrees when this is the case). In one or more embodiments, the roll edge portion does not obey user preferences for display orientation and auto rotate/device orientation.

In one or more embodiments, content presented on the rear-facing portion of the flexible display 104 is always rotated by 180-degrees relative to content presented on the front-facing portion when the electronic device 100 is being held vertically, as is the case, and as can be seen, in FIGS. 3-4. In one or more embodiments, the rear-facing portion does not obey user preferences for display orientation and auto-rotate/device orientation.

Accordingly, in one or more embodiments one or more processors (114) of the electronic device (100) dynamically remap multiple translating display root segments based upon the position of the flexible display 104 relative to the single device housing 101. The one or more processors 114 can independently manage orientation and rotation on each of the root segments of the flexible display 104, be they the front-facing portion, the rear-facing portion, or the roll edge portion. In one or more embodiments, this management occurs independently based upon which side of the electronic device 100 the segment is currently positioned upon, combined with sensor inputs to identify if the electronic device 100 is face down or face up.

As shown in FIG. 2, the blade assembly 102 is operable to slide around the single device housing 101 such that the blade 126 slides away from the single device housing 101 to change an overall length of the flexible display 104 as viewed from the front of the electronic device 100. As will be described below with reference to FIGS. 26-31, in one or more embodiments this aligns some permanent magnets to define an audio output device while other permanent magnets may misalign. Illustrating by example, where the blade assembly 102 carries a first permanent magnet that is mechanically coupled to the blade assembly 102 and the device housing 101 comprises a second permanent magnet that is mechanically coupled to a surface of the device housing 101, in one or more embodiments when the blade assembly 102 translates to the extended position this causes the first permanent magnet and the second permanent magnet to axially align, thereby defining an audio output device that can deliver acoustic energy to an environment of the electronic device 100 through the blade assembly 102.

However, when the blade assembly 102 translates to the retracted position, this would result in the first permanent magnet and the second permanent magnet axially misaligning. Advantageously, in one or more embodiments the blade assembly 102 comprises a third permanent magnet mechanically coupled thereto. When the blade assembly 102 reaches the retracted position, the third permanent magnet and second permanent magnet axially align to define another audio output device operable to deliver acoustic energy to an environment of the electronic device 100 through the blade assembly 102. Additional permanent magnets can be included to define additional audio output devices as well.

Accordingly, in one or more embodiments the electronic device 100 includes a single device housing 101 with a blade assembly 102 coupled to two major surfaces of the single device housing 101 and wrapping around at least one minor surface of the electronic device 100 such that the blade assembly 102 can slide relative to the single device housing 101 between the retracted position 300, the extended position 200, and the peek position 500 revealing a front-facing image capture device 501. A translation mechanism (105) is operable to slide the blade assembly 102 relative to the device housing 101 between the extended position, retracted position, and peek position.

In one or more embodiments, a first permanent magnet is mechanically coupled to the blade assembly 102, while a second permanent magnet is mechanically coupled to a surface carried by the device housing 101. Translation of the blade assembly 102, for example, to a predefined position causes the first permanent magnet and second permanent magnet to axially align, thereby defining an audio output device. The predefined position can be defined as desired based upon application. In one or more embodiments, the predefined position comprises one or both of the extended position and/or retracted position but can comprise the peek position as well. Other configurations for other predefined positions will be obvious to those of ordinary skill in the art having the benefit of this disclosure.

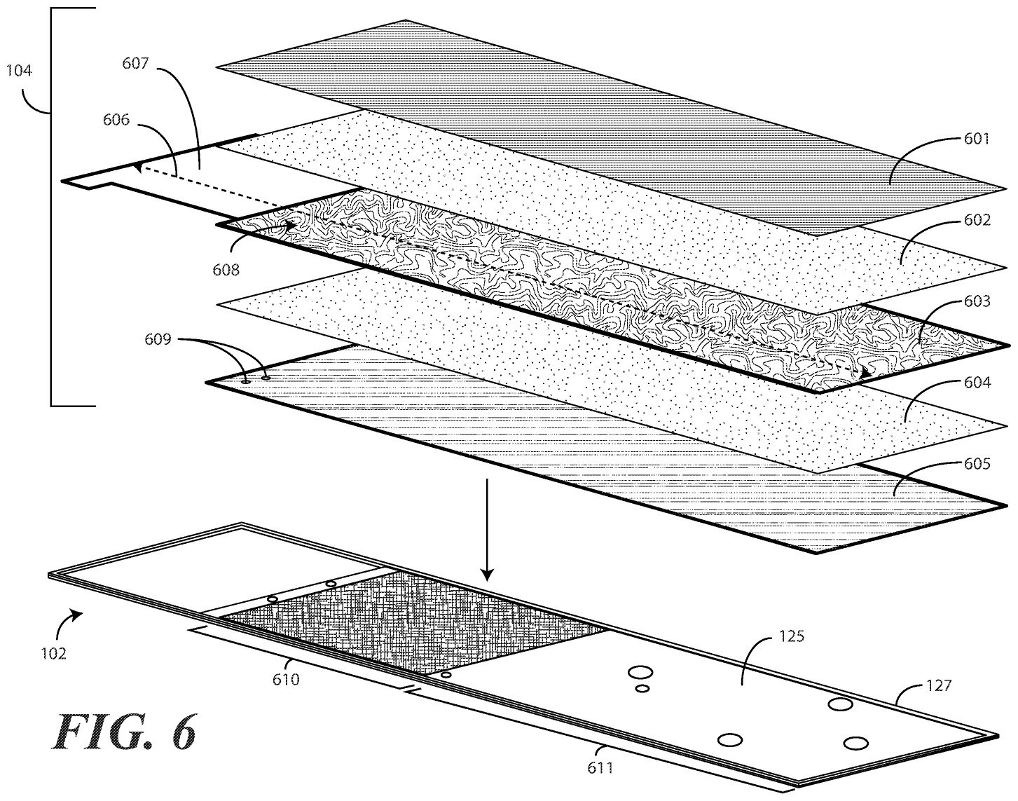

Turning now to FIG. 6, illustrated therein is the flexible display 104 shown in an exploded view, along with the blade assembly 102. As shown in FIG. 6, in one or more embodiments the flexible display 104 comprises one or more layers that are coupled or laminated together to complete the flexible display 104. In one or more embodiments, these layers comprise a flexible protective cover 601, a first adhesive layer 602, a flexible display layer 603, a second adhesive layer 604, and a flexible substrate 605. Other configurations of layers suitable for manufacturing the flexible display 104 will be obvious to those of ordinary skill in the art having the benefit of this disclosure.

Beginning from the top of the layer stack, in one or more embodiments the flexible protective cover 601 comprises an optically transparent substrate. In one or more embodiments the flexible protective cover 601 may be manufactured from an optically transparent material such a thin film sheet of a thermoplastic material. Illustrating by example, in one embodiment the flexible protective cover 601 is manufactured from a layer of optically transparent polyamide having a thickness of about eighty microns. In another embodiment, the flexible protective cover 601 is manufactured from a layer of optically transparent polycarbonate having a thickness of about eighty microns. Other materials suitable for manufacturing the flexible protective cover 601 will be obvious to those of ordinary skill in the art having the benefit of this disclosure.

In one or more embodiments the flexible protective cover 601 functions as a fascia by defining a cover for the flexible display layer 603. In one or more embodiments the flexible protective cover 601 is optically transparent, in that light can pass through the flexible protective cover 601 so that objects behind the flexible protective cover 601 can be distinctly seen. The flexible protective cover 601 may optionally include an ultra-violet barrier. Such a barrier can be useful in improving the visibility of flexible display layer 603 in one or more embodiments.

Beneath the flexible protective cover 601 is a first adhesive layer 602. In one or more embodiments, the first adhesive layer 602 comprises an optically transparent adhesive. The optically transparent adhesive can be applied to two sides of a thin, optically transparent substrate such that the first adhesive layer 602 functions as an optically transparent layer having optically transparent adhesive on both sides. Where so configured, in one or more embodiments the first adhesive layer 602 has a thickness of about fifty microns. This optically transparent version of “double-sided tape” can then be spooled and applied between the flexible protective cover 601 and the flexible display layer 603 to couple the two together.

In other embodiments the first adhesive layer 602 will instead be applied between the flexible protective cover 601 and the flexible display layer 603 as an optically transparent liquid, gel, as a homogeneous adhesive layer, or in the form of another medium. Where so configured, the first adhesive layer 602 can optionally be cured by heat, ultraviolet light, or other techniques. Other examples of materials suitable for use as the first adhesive layer 602 will be obvious to those of ordinary skill in the art having the benefit of this disclosure. In one or more embodiments, the first adhesive layer 602 mechanically couples the flexible display layer 603 to the flexible protective cover 601.

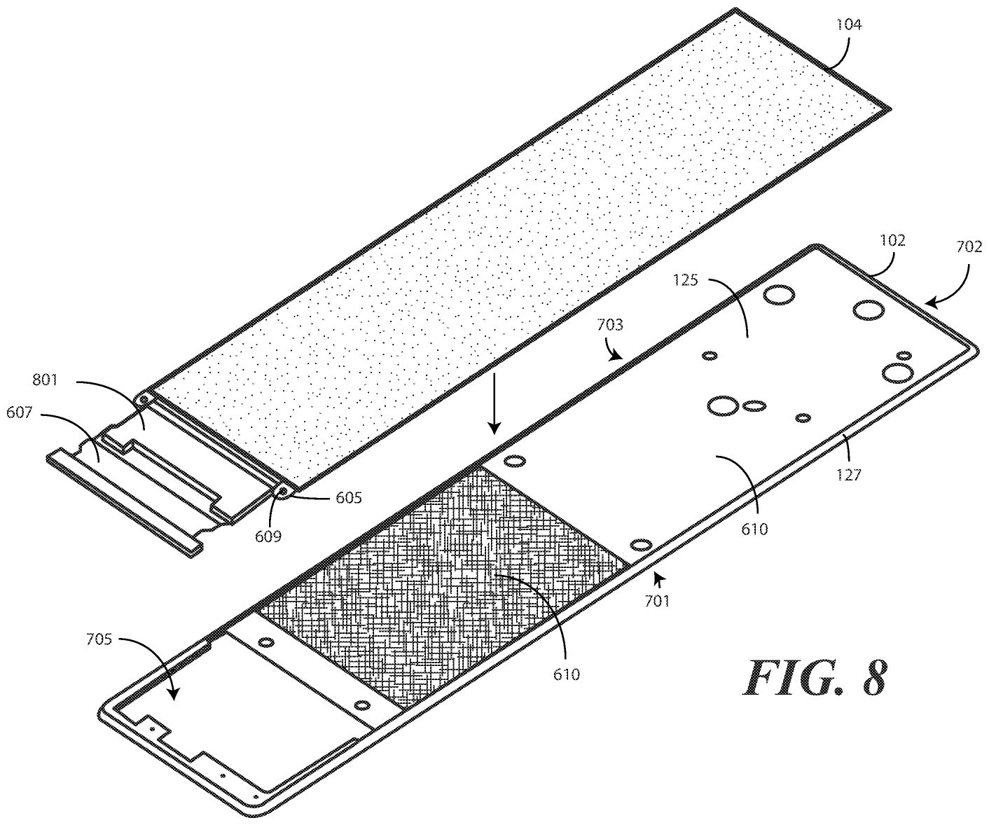

In one or more embodiments, the flexible display layer 603 is situated between the flexible substrate 605 and the flexible protective cover 601. In one or more embodiments, the flexible display layer 603 is longer along a major axis 606 of the flexible display layer 603, and thus the flexible display 104 itself, than is the image producing portion 608 of the flexible display 104. For instance, as shown in FIG. 6 the flexible display layer 603 includes a T-shaped tongue 607 that extends beyond the image producing portion 608 of the flexible display layer 603. As will be shown in FIG. 8 below, in one or more embodiments electronic circuit components configured to operate the image producing portion 608 of the flexible display layer 603, connectors, and other components can be coupled to this T-shaped tongue 607 in one or more embodiments. Thus, in this illustrative embodiment the T-shaped tongue 607 extends distally beyond terminal ends of the other layers of the flexible display 104. While the T-shaped tongue 607 is T-shaped in this illustrative embodiment, it can take other shapes as well as will be obvious to those of ordinary skill in the art having the benefit of this disclosure.

The flexible display layer 603 can optionally be touch-sensitive. In one or more embodiments, the flexible display layer 603 is configured as an organic light emitting diode (OLED) display layer. When coupled to the flexible substrate 605, the flexible display layer 603 can bend in accordance with various bending radii. For example, some embodiments allow bending radii of between thirty and six hundred millimeters. Other substrates allow bending radii of around five millimeters to provide a display that is foldable through active bending. Other displays can be configured to accommodate both bends and folds.

In one or more embodiments the flexible display layer 603 may be formed from multiple layers of flexible material such as flexible sheets of polymer or other materials. Illustrating by example, the flexible display layer 603 can include a layer of optically pellucid electrical conductors, a polarizer layer, one or more optically transparent substrates, and layers of electronic control circuitry such as thin film transistors to actuate pixels and one or more capacitors for energy storage. In one or more embodiments, the flexible display layer 603 has a thickness of about 130 microns.

In one or more embodiments, to be touch sensitive the flexible display layer 603 includes a layer including one or more optically transparent electrodes. In one or more embodiments, the flexible display layer 603 includes an organic light emitting diode layer configured to images and other information to a user. The organic light emitting diode layer can include one or more pixel structures arranged in an array, with each pixel structure comprising a plurality of electroluminescent elements such as organic light emitting diodes. These various layers can be coupled to one or more optically transparent substrates of the flexible display layer 603. Other layers suitable for inclusion with the flexible display layer 603 will be obvious to those of ordinary skill in the art having the benefit of this disclosure.

In one or more embodiments, the flexible display layer 603 is coupled to a flexible substrate 605 by a second adhesive layer 604. In other embodiments, a layer above the flexible display layer 603 can be configured with enough stiffness to make the flexible substrate 605 unnecessary. For example, in an embodiment where the flexible protective cover 601 is configured with enough stiffness to provide sufficient protection for the flexible display 104 during bending, the flexible substrate 605 may be omitted.

In one or more embodiments, the flexible substrate 605 comprises a thin layer of steel. Illustrating by example, in one or more embodiments the flexible substrate 605 comprises a steel layer with a thickness of about thirty microns. While thin, flexible steel works well in practice, it will be obvious to those of ordinary skill in the art having the benefit of this disclosure that other materials can be used for the flexible substrate 605 as well. For instance, in another embodiment the flexible substrate 605 is manufactured from a thin layer of thermoplastic material.

In one or more embodiments, to simplify manufacture, the second adhesive layer 604 is identical to the first adhesive layer 602 and comprises an optically transparent adhesive. However, since the second adhesive layer 604 is coupled between the flexible display layer 603 and the flexible substrate 605, i.e., under the flexible display layer 603, an optically transparent adhesive is not a requirement. The second adhesive layer 604 could be partially optically transparent or not optically transparent at all in other embodiments.

Regardless of whether the second adhesive layer 604 is optically transparent, in one or more embodiments the adhesive of the second adhesive layer 604 is applied to two sides of a thin, flexible substrate. Where so configured, in one or more embodiments the second adhesive layer 604 has a thickness of about fifty microns. This extremely thin version of “double-sided tape” can then be spooled and applied between the flexible display layer 603 and the flexible substrate 605 to couple the two together.

In other embodiments, as with the first adhesive layer 602, the second adhesive layer 604 will instead be applied between the flexible display layer 603 and the flexible substrate as a liquid, gel, as a homogeneous layer, or in the form of another medium. Where so configured, the second adhesive layer 604 can optionally be cured by heat, ultraviolet light, or other techniques. Other examples of materials suitable for use as the second adhesive layer 604 will be obvious to those of ordinary skill in the art having the benefit of this disclosure.

In this illustrative embodiment, the flexible display 104 is supported by not only the flexible substrate 605, but by the blade assembly 102 as well. As previously described, in one or more embodiments the blade assembly 102 includes a blade substrate 125. In one or more embodiments, the blade substrate 125 comprises a layer of steel. In one or more embodiments, the blade substrate 125 is thicker than the flexible substrate 605. Illustrating by example, in one or more embodiments when the flexible substrate 605 comprises a steel layer with a thickness of about thirty microns, the blade substrate 125 comprises a layer of steel having a thickness of about one hundred microns.

In one or more embodiments, the blade substrate 125 comprises a rigid, substantially planar support layer. Illustrating by example, the blade substrate 125 can be manufactured from stainless steel in one or more embodiments. In another embodiment, the blade substrate 125 is manufactured from a thin, rigid thermoplastic sheet. Other materials can be used in manufacturing the blade substrate 125 as well. For example, the material nitinol, which is a nickel-titanium alloy, can be used to manufacture the blade substrate 125. Other rigid, substantially planar materials will be obvious to those of ordinary skill in the art having the benefit of this disclosure.

Accordingly, the blade substrate 125 defines another mechanical support for the flexible display 104. In one or more embodiments, the blade substrate 125 is the stiffest layer of the overall assembly of FIG. 6. In one or more embodiments the blade substrate 125 is manufactured from stainless steel with a thickness of about one hundred microns. In another embodiment, the blade substrate 125 is manufactured from a flexible plastic. Other materials from which the blade substrate 125 can be manufactured will be obvious to those of ordinary skill in the art having the benefit of this disclosure. For instance, in another embodiment the blade substrate 125 is manufactured from carbon fiber, and so forth. In one or more embodiments, the blade substrate 125 includes a reinforcing border comprising a thicker layer of material to further protect the flexible display 104 when the blade assembly 102 is in the extended position (200).

In one or more embodiments, the flexible substrate 605 is slightly longer along a major axis of the flexible substrate 605 than is the image producing portion 608 of the flexible display 104. Since the T-shaped tongue 607 is T-shaped, this allows one or more apertures 609 to be exposed on either side of the base of the T of the T-shaped tongue 607. In one or more embodiments, this extra length along the major axis provided by the flexible substrate 605 allows one or more fasteners to rigidly couple the first end of the flexible substrate 605 to a tensioner.

Embodiments of the disclosure contemplate that some of the layers comprising the flexible display 104 are stiffer than others. Similarly, other layers of the flexible display 104 are softer than others. For example, where the flexible substrate 605 is manufactured from a metal, one example of which is stainless steel, this layer is stiffer than either the first adhesive layer 602 or the second adhesive layer 604. In one or more embodiments, the stainless steel is stiffer than the flexible display layer 603 as well. In one or more embodiments, the flexible substrate 605 is the stiffest layer in the flexible display 104 while the first adhesive layer and the second adhesive layer 604 are the softest layers of the flexible display 104. The flexible protective cover 601 and the flexible display layer 603 have a stiffness that falls between that of the flexible substrate 605 and the adhesive layers in one or more embodiments.

In one or more embodiments, the various layers of the flexible display 104 are laminated together in a substantially planar configuration. Said differently, in one or more embodiments the flexible substrate 605 is configured as a substantially planar substrate. The second adhesive layer 604 can be attached to this substantially planar substrate, with the flexible display layer 603 then attached to the second adhesive layer 604. The first adhesive layer 602 can be attached to the flexible display layer 603, with the flexible protective cover 601 attached to the first adhesive layer 602.

To ensure proper coupling, the resulting flexible display layer 603 can be cured, such as in an autoclave at a predefined temperature for a predefined duration. Where employed, such curing allows any air bubbles or other imperfections in the various layers to be corrected. In one or more embodiments, since the flexible substrate 605 is configured as a substantially planar substrate, the resulting flexible display 104 is substantially planar as well.

In one or more embodiments, the blade substrate 125 of the blade assembly 102 includes both a flexible portion 610 and a rigid portion 611. Since the blade substrate 125 is manufactured from a metal in one or more embodiments, one example of which is steel having a thickness of one hundred microns, the rigid portion 611 gets its rigidity from the material from which it is manufactured. If, for example, the blade substrate 125 were manufactured from a thermoplastic material, in one or more embodiments this thermoplastic material would have enough rigidity that the rigid portion 611 would be rigid. Since the rigid portion 611 only slides along flat major surfaces of the translation surfaces defined by the single device housing (101), it does not need to bend. Moreover, rigidity helps to protect portions of the flexible display 104 that extend beyond ends of the single device housing (101).

By contrast, the flexible portion 610 need to wrap around minor faces of the single device housing (101) where the display roller mechanism (105) is situated. Since the flexible portion 610 is manufactured from the same material as the rigid portion 611 when the blade substrate 125 is manufactured as a single unitary part, in one or more embodiments it includes a plurality of apertures cut through the blade substrate 125 allowing the material to bend. Illustrating by example, in one or more embodiments where the blade substrate 125 is manufactured from steel, a plurality of chemically or laser etched apertures can allow the flexible portion 610 to tightly wrap around minor faces of the single device housing (101) where the display roller mechanism (105) is situated.

Thus, in one or more embodiments the blade substrate 125 is partially rigid and partially flexible. Portions of the blade substrate 125 that slide along the major surfaces of the single device housing (101) are configured to be substantially rigid, while portions of the blade substrate 125 that pass around the minor surfaces of the single device housing (101) are configured to be flexible so that they can curl around those minor surfaces.

In one or more embodiments, the blade assembly 102 also includes a silicone border 127 positioned around a perimeter of the blade substrate 125. In one or more embodiments, the silicone border 127 surrounds and protects the edges of the flexible display 104 when the flexible display 104 is attached to the blade substrate 125 of the blade assembly 102. In one or more embodiments, the silicone border 127 is co-molded around the perimeter of the blade substrate 125.

In one or more embodiments, the rigid portion 611 of the blade substrate 125 can define one or more apertures. These apertures can be used for a variety of purposes. Illustrating by example, some of the apertures can be used to rigidly fasten the blade assembly 102 to a translation mechanism, one example of which was the display roller mechanism (105) of FIG. 1. Additionally, some of the apertures can contain magnets. Hall-effect sensors positioned in the single device housing (101) to which the blade assembly 102 is coupled can then detect the positions of these magnets such that the one or more processors (114) can determine whether the blade assembly 102 and flexible display 104 are in the extended position (200), the retracted position (300), the peek position (500), or somewhere in between.

In one or more embodiments, the flexible display 104 coupled to the blade substrate 125 of the blade assembly 102 within the confines of the silicone border 127. Illustrating by example, in one or more embodiments a first end of the flexible display 104 is adhesively coupled to the rigid portion 611 of the blade substrate 125 of the blade assembly 102. The other end of the flexible display 104 can then be rigidly coupled to a tensioner by passing fasteners through the apertures 609 of the flexible substrate.

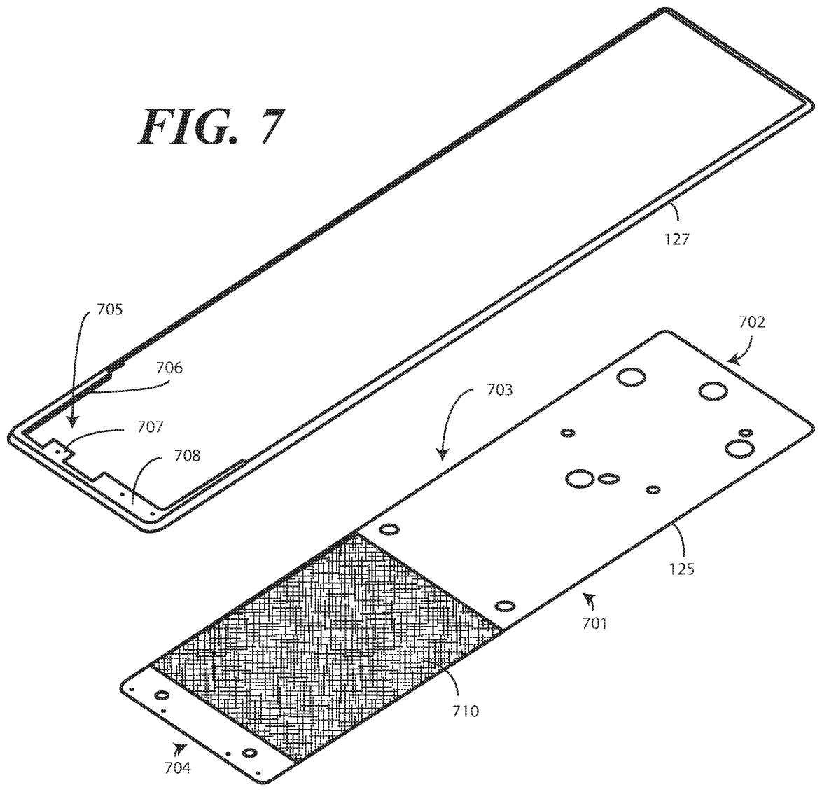

Turning now to FIG. 7, illustrated therein is the blade substrate 125 and silicone border 127 shown in an exploded view. A shown, the silicone border 127 defines a singular, contiguous, unitary piece of silicone. In the illustrative embodiment of FIG. 7, the silicone border 127 surrounds three sides 701,702,703 of the blade substrate 125, and extends beyond minor side 704 to define a receiving recess 705 that can accommodate mechanical and electrical components such as electronic circuit components to power and control the flexible display (104) that will situate within the perimeter defined by the silicone border 127, a tensioner to keep the flexible display (104) flat across the flexible portion 610 of the blade substrate 125, flexible circuits, and other components.

In this illustrative embodiment, the portions 706,707,708 of the silicone border 127 extending beyond the minor side 704 of the blade substrate 125 surrounding the receiving recess 705 are thicker than are the other portions of the silicone border 127 that will surround the flexible display (104). This allows for components to be placed within the receiving recess 705.

Turning now to FIG. 8, illustrated therein is the flexible display 104 and the blade assembly 102 with the silicone border 127 over-molded on the blade substrate 125. As shown, the silicone border 127 surrounds three sides 701,702,703 of the blade substrate 125 and extends beyond minor side 704 to define a receiving recess 705 that can accommodate mechanical and electrical components.

Electronic circuits 801 operable to power and control the flexible display 104 have been coupled to the T-shaped tongue 607 of the flexible display layer (603). Additionally, a mechanical connector 802 has been connected to the top of the T on the T-shaped tongue 607. In this illustrative embodiment, the flexible substrate 605 extends beyond a distal end of the flexible display layer (603) so that the apertures 609 defined therein can be coupled to a tensioner to ensure that the flexible display 104 stays flat around the flexible portion 610 of the blade substrate 125 when the flexible portion 610 of the blade substrate 125 passes around a rotor positioned at the end of a single device housing (101).

The blade assembly 102 can be fixedly coupled to the flexible display 104 in one or more embodiments. Illustrating by example, where the blade substrate 125 defines both a rigid portion 611 and a flexible portion 610, in one or more embodiments the flexible display 104 is coupled to the rigid portion 611 by an adhesive or other coupling mechanism. A tensioner can then be positioned in the receiving recess 705. In one or more embodiments, the tensioner rigidly couples with fasteners to the apertures 609 of the flexible substrate 605 to keep the flexible display 104 flat across the flexible portion 610, regardless of how the flexible portion 610 is being bent around the minor surface of a single device housing or its corresponding rotor.

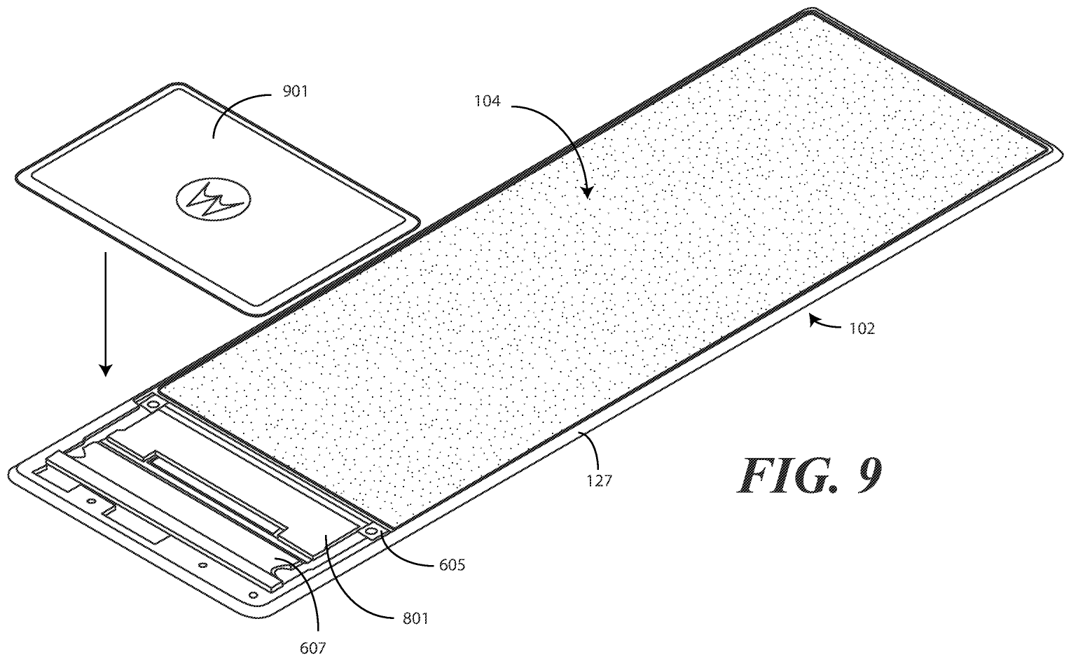

Turning now to FIG. 9, illustrated therein is the flexible display 104 after being coupled to the blade assembly 102. As shown, the silicone border 127 surrounds the flexible display 104, with the silicone border 127 surrounding and abutting three sides of the flexible display layer (603).

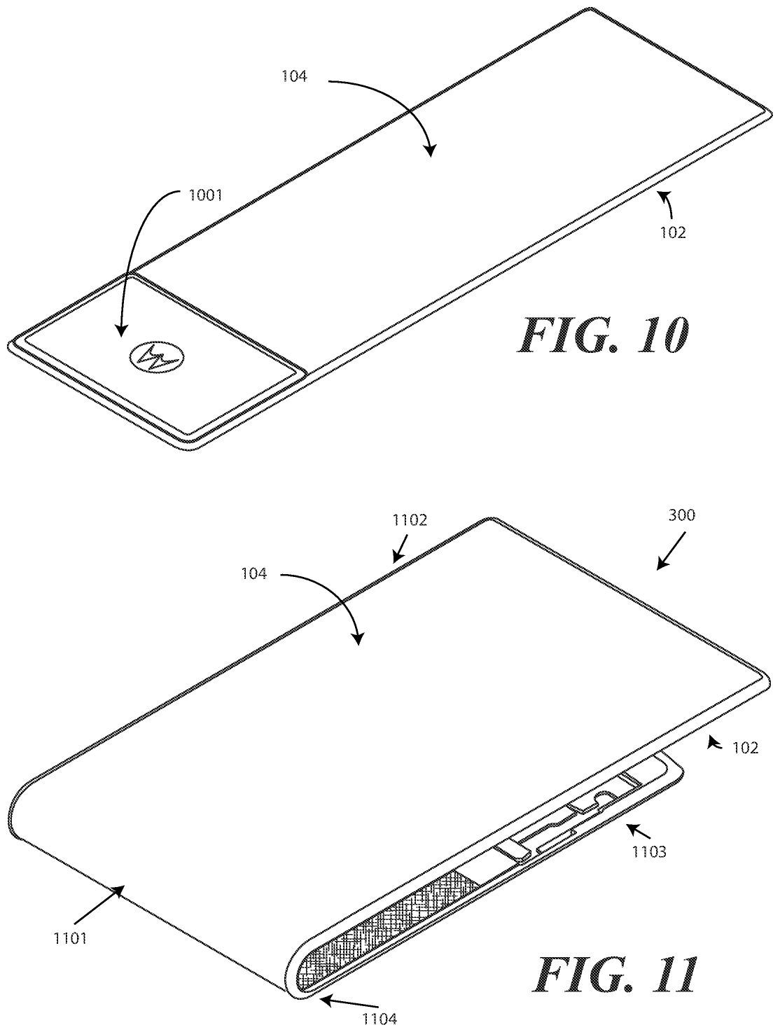

A flexible substrate is then connected to the electronic circuits 801 carried by the T-shaped tongue. Additionally, a tensioner can be coupled to the flexible substrate 605. Thereafter, a cover 901 is attached to the silicone border 127 atop the electronic circuits 801 and other components situated on or around the T-shaped tongue. This portion the blade assembly 102 where the components are stored beneath the cover 901 is affectionately known as the “backpack.” Turning to FIG. 10, illustrated therein is the blade assembly 102 with its backpack 1001 completely configured.

In one or more embodiments, the flexible display 104 and blade assembly 102 are configured to wrap around a minor surface of a device housing where a display roller mechanism is situated. In one or more embodiments, the display roller mechanism includes a rotor that is positioned within a curvilinear section of the flexible display 104 and blade assembly 102. When placed within a device housing of an electronic device, translation of a translation mechanism causes translation of the blade assembly 102, which in turn causes rotation of the rotor. The result is a linear translation of the flexible display 104 and blade assembly 102 across a translation surface of the device housing by drawing the flexible display 104 and the blade assembly 102 around the rotor.

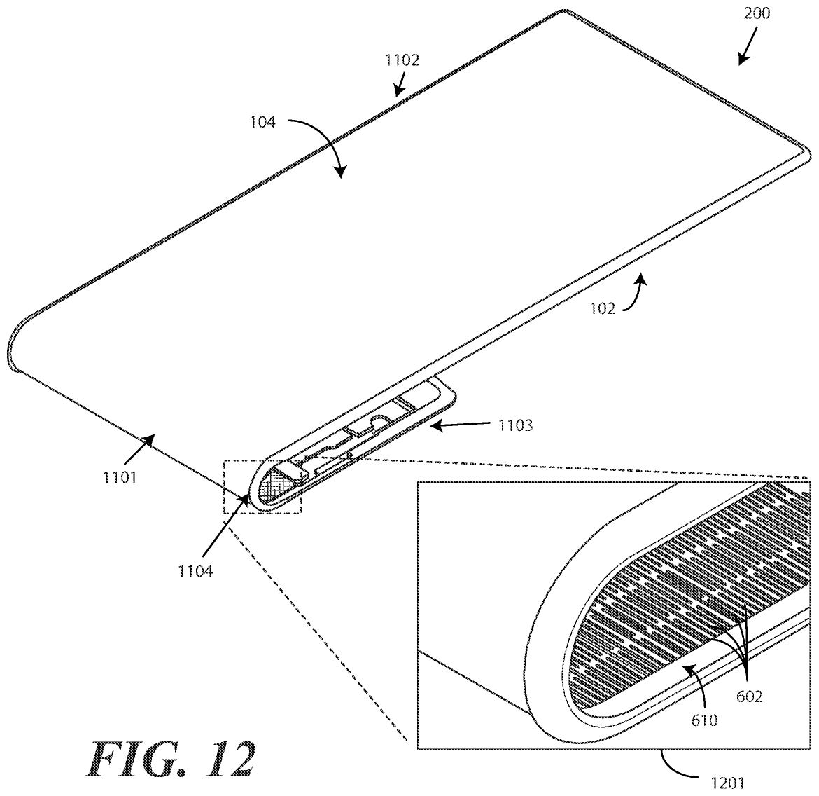

That the blade substrate (125) of the blade assembly 102 includes a flexible portion (610) allows the blade assembly 102 and flexible display 104 to deform around a device housing, one example of which is the single device housing (101) of FIG. 1. Illustrating by example, turning now to FIGS. 11-12, illustrated therein is the blade assembly 102 and flexible display deformed to create a curvilinear section 1101 and two linear sections 1102,1103. The flexible display 104 and blade assembly 102 are shown as they would be in the retracted position 300 in FIG. 11. The flexible display 104 and the blade assembly 102 are shown as they would be in the extended position 200 in FIG. 12. The enlarged view 1201 of FIG. 12 shows how the apertures defined by the chemical etching of the blade substrate 125 easily allow the blade substrate 125 to bend around the curvilinear section 1101 while maintaining a rigid support structure beneath the flexible display 104 in the two linear sections 1102,1103.

In one or more embodiments, the first linear section 1102 and the second linear section 1103 are configured to slide between the retracted position 300 of FIG. 11 and the extended position 200 of FIG. 12. The flexible display 104 is coupled to the blade assembly 102 and therefore translates with the blade assembly 102 along a translation surface defined by a device housing of an electronic device.

In one or more embodiments, the linear sections 1102,1103 of the blade assembly 102 are positioned between the flexible display 104 and the translation surface. A rotor is then positioned within a curvilinear section 1101 of the blade assembly 102. When a translation mechanism causes the linear sections 1102,1103 of the blade assembly 102 to move across the translation surface defined by the device housing, the rotor rotates with the flexible portion 610 passing along the rotor while the rotor rotates.

As shown in FIGS. 11-12, in one or more embodiments a cross section of both the blade assembly 102 and the flexible display 104 defines a J-shape with a curved portion of the J-shape, defined by the curvilinear section 1101, configured to wrap around a rotor and an upper portion of the J-shape, defined by linear section 1102, passing across a translation surface defined by a device housing. When the translators of a translation mechanism drive the blade assembly 102, the upper portion of the J-shape becomes longer as the flexible display 104 translates around the rotor with the blade assembly 102 extending further from of the device housing. This can be seen in FIGS. 11-12 by comparing the extended position 200 of FIG. 12 to the retracted position 300 of FIG. 11.

When the translators of the translation mechanism drive the blade assembly 102 in the opposite direction, e.g., driving the blade assembly 102 from the extended position 200 of FIG. 12 to the retracted position 300 of FIG. 11, the upper portion of the J-shape becomes shorter as the reverse operation occurs. Thus, when the translation mechanism drives the blade assembly 102 carrying the flexible display 104, the flexible display 104 deforms at different locations as it wraps and passes around the rotor.

It should be understood that a more traditional “J-shape” is principally defined when the blade assembly 102 is transitioned to the extended position 200 of FIG. 12. Depending upon the length of the blade assembly 102 and flexible display 104, combined with the amount the translation mechanism can cause the blade assembly 102 to slide around the rotor, the J-shape may transition to other shapes as well, including a U-shape where the upper and lower portions of the blade assembly 102 and/or flexible display 104 are substantially symmetrical. Such a U-shape forms when the blade assembly is in the peek position but is substantially formed in the retracted position 300 of FIG. 3. In other embodiments, depending upon construction, the blade assembly 102 may even transition to an inverted J-shape where the upper portion of the blade assembly 102 and/or flexible display 104 is shorter than the lower portion of the blade assembly 102 and/or flexible display 104, and so forth.

In one or more embodiments, the translators and rotor of the translation mechanism not only facilitate the “extension” of the flexible display 104 that occurs during an extending or “rising” operation, but also works to improve the reliability and usability of the flexible display 104 as well. This is true because the rotor defines a service loop 1104 in the curvilinear section 1101 with a relatively large radius compared to the minimum bending radius of the flexible display 104. The service loop 1104 prevents the flexible display 104 from being damaged or developing memory in the curved state occurring as the flexible display 104 defines the curvilinear section 1101 wrapping around the rotor in the extended position 200, retracted position 300, and peek position (500).

Using such a mechanical assembly, the flexible display 104 maintains a flat upper portion of the J-shape defined by the first linear section 1102 when sliding. Additionally, the flexible display 104 wraps tightly around the rotor with the lower portion of the J-shape defined by the second linear section 1103 remaining flat against the lower surface of a device housing as well. The blade assembly 102 and tensioner combination, which are rigidly affixed to the translation mechanism, precludes the flexible display 104 from crumpling or bunching when sliding around the device housing between the extended position 200, the retracted position 300, and the peek position (500). This rigid coupling combined with moving tensioner ensures a straight and true translation of the flexible display 104 across a first major surface of an electronic device, around the rotor of the electronic device positioned at a minor surface of the device housing, and across a second major surface of the electronic device.

In one or more embodiments additional support components can be attached to the blade assembly 102 to one or more of provide additional support for the flexible display 104, ease translation of the blade assembly 102 around a device housing, or combinations thereof.

As noted above, in one or more embodiments a blade assembly 102 is coupled to the flexible display 104. In contrast to sliding devices that include multiple device housings, embodiments of the disclosure provide an electronic device with a sliding display that includes only on device housing. The blade assembly 102 is configured as a mechanical chassis that allows the flexible display 104 to translate along a translation surface defined by major and minor surfaces of the single device housing.

In one or more embodiments, the blade assembly 102 also provides a mechanical support for portions of the flexible display 104 that extend beyond the top edge of the single device housing when the blade assembly 102 and flexible display 104 are in the extended position. The blade assembly 102 can include a blade substrate (125) that is unitary, but that defines both flexible portions and rigid portions. The blade substrate (125) can comprise the silicone border 127 that surrounds and protects the edges of the flexible display 104.

A low-friction dynamic bending laminate stack (128) and blade (126) can be positioned between the blade assembly 102 and the translation surfaces defined by the single device housing (101). In one or more embodiments, the blade (126) and the low-friction dynamic bending laminate stack (128) are positioned between the blade assembly 102 and the translation surfaces defined a device housing to which the blade assembly 102 is attached.

The blade (126) supports portions of the blade assembly 102 and flexible display 104 that extend beyond the top edge of the device housing when the blade assembly 102 is transitioned to the extended position. Since this blade (126) needs to be rigid to support those portions of the blade assembly 102 and the flexible display 104, it is not able to bend around the flexible portions of the blade substrate (125) of the blade assembly 102. To prevent gaps or steps from occurring where the blade (126) terminates, in one or more embodiments a low-friction dynamic bending laminate stack (128) spans the remainder of the blade assembly 102 and abuts the transition surfaces defined by the single device housing.

In one or more embodiments, the blade (126) comprises a layer of steel. In one or more embodiments, the blade (126) has a thickness that is greater than the thickness of either the blade substrate (125) of the blade assembly 102 or the flexible substrate (605) of the flexible display 104. Illustrating by example, in one or more embodiments the blade (126) comprises a layer of steel having a thickness of five hundred microns or 0.5 mils.

In one or more embodiments, the blade (126) comprises a rigid, substantially planar support layer. Illustrating by example, the blade (126) can be manufactured from aluminum, steel, or stainless steel in one or more embodiments. In another embodiment, the blade (126) is manufactured from a rigid thermoplastic sheet. Other materials can be used in manufacturing the blade substrate (125) as well. For example, nitinol can be used to manufacture the blade (126) as well.

In one or more embodiments, the blade (126) is the stiffest layer of the overall assembly. In one or more embodiments the blade (126) is manufactured from stainless steel with a thickness of about five hundred microns. In another embodiment, the blade (126) is manufactured from carbon fiber. Other materials from which the blade (126) can be manufactured will be obvious to those of ordinary skill in the art having the benefit of this disclosure.

In one or more embodiments, the low-friction dynamic bending laminate stack (128) comprises a plurality of layers. When assembled, the low-friction dynamic bending laminate stack (128) adds a layer to the blade assembly 102 that improves the lubricity of the overall assembly to allow for smooth motion of the blade assembly 102 and flexible display 104 across the translation surfaces of a device housing. Moreover, when abutting a blade (126), the low-friction dynamic bending laminate stack (128) prevents features on other layers of the assembly from degrading the ability of the blade assembly 102 and flexible display 104 to translate across those translation surfaces.

In one or more embodiments, the low-friction dynamic bending laminate stack (128) allows for “low-friction” sliding across a stationary surface combined with the ability to cyclically bend and/or roll around a rotor. In one or more embodiments, the low-friction dynamic bending laminate stack (128) interfaces and abuts the blade (126) to improve lubricity.

In one or more embodiments, the uppermost layer of the low-friction dynamic bending laminate stack (128) is a pressure sensitive adhesive layer. This pressure sensitive adhesive layer allows the low-friction dynamic bending laminate stack (128) to adhere to the underside of the blade assembly 102.

Beneath this pressure sensitive adhesive layer is a strain tolerant foam layer in one or more embodiments. Examples of strain tolerant foams suitable for use as the strain tolerant foam layer include silicone, low-density polyethylene, or other materials that provide sufficient thickness so as to allow the low-friction dynamic bending laminate stack (128) to match the thickness of the blade (126) while reducing internal stresses and allowing bending.

Beneath the strain tolerant foam layer is another pressure sensitive adhesive layer in one or more embodiments. This pressure sensitive adhesive layer couples a flexible substrate having a strain relief cutout pattern formed therein. The flexible substrate can be manufactured from metal or plastic or other materials. Illustrating by example, in one or more embodiments the flexible substrate comprises a steel layer with a thickness of about thirty microns. While thin, flexible steel works well in practice, it will be obvious to those of ordinary skill in the art having the benefit of this disclosure that other materials can be used for the flexible substrate as well. For instance, in another embodiment the flexible substrate is manufactured from a thin layer of thermoplastic material.

Another layer of pressure sensitive adhesive then couples the flexible substrate to a low-friction layer in one or more embodiments. In one or more embodiments, the low-friction layer comprises a substrate with Teflon.sup.™ attached thereto. In another embodiment, the low-friction layer comprises a layer of polytetrafluoroethylene, which is a synthetic fluoropolymer of tetrafluoroethylene. This material is best known for its non-stick properties and adds a lubricity to the low-friction dynamic bending laminate stack (128) that allows the overall assembly to slide smoothly. Moreover, the low-friction layer prevents the strain relief cutout pattern in the flexible substrate from snagging on surface imperfections and transitions on the device housing to which the assembly is attached. In short, the low-friction layer greatly improves the lubricity of the overall assembly.

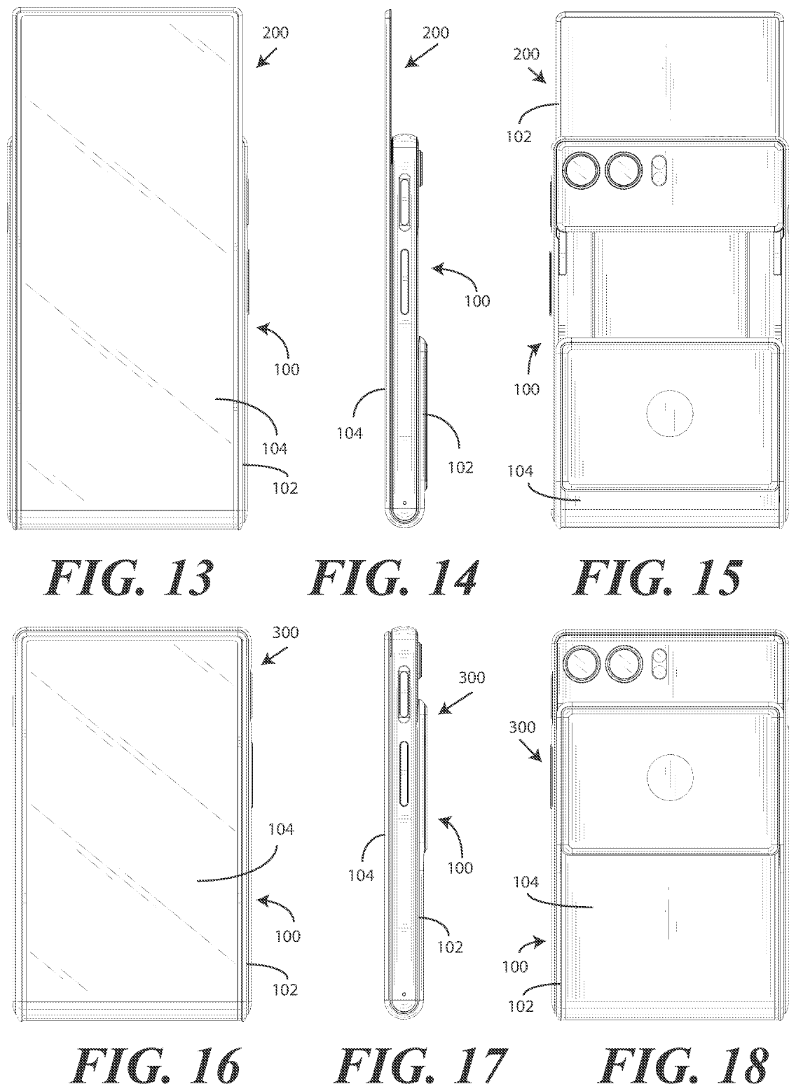

FIGS. 13-18 illustrate the electronic device 100 of FIG. 1 as fully assembled in both the extended position 200 and retracted position 300. Embodiments of the disclosure contemplate that in addition to having distinctly unique utilitarian features, electronic devices configured in accordance with embodiments of the disclosure have distinctly unique ornamental features as well. Many of these ornamental features are visible in FIGS. 13-18.

FIG. 13 illustrates a front elevation view of the electronic device 100 in the extended position 200, while FIG. 14 illustrates a side elevation view of the electronic device 100 in the extended position 200. FIG. 15 then provides a rear elevation view of the electronic device 100 in the extended position 200 as well.

FIG. 16 illustrates a front elevation view of the electronic device 100 in the retracted position 300, while FIG. 17 illustrates a side elevation view of the electronic device 100 in the retracted position 300. FIG. 18 then provides a rear elevation view of the electronic device 100 in the retracted position 300.

As can be seen by comparing these figures, the blade assembly 102 is able to slide around the single device housing 101 such that the blade 126 slides away from the single device housing 101 to change the apparent overall length of the flexible display 104 as viewed from the front of the electronic device 100. The blade assembly 102 can also slide in an opposite direction around the single device housing 101 to the retracted position 300, where similar amounts of the flexible display 104 are visible on the front side of the electronic device 100 and the rear side of the electronic device 100. Graphics, images, user actuation targets, and other indicia can be presented anywhere on the flexible display 104, including on the front side of the electronic device 100, the rear side of the electronic device 100, or the lower end of the electronic device 100.

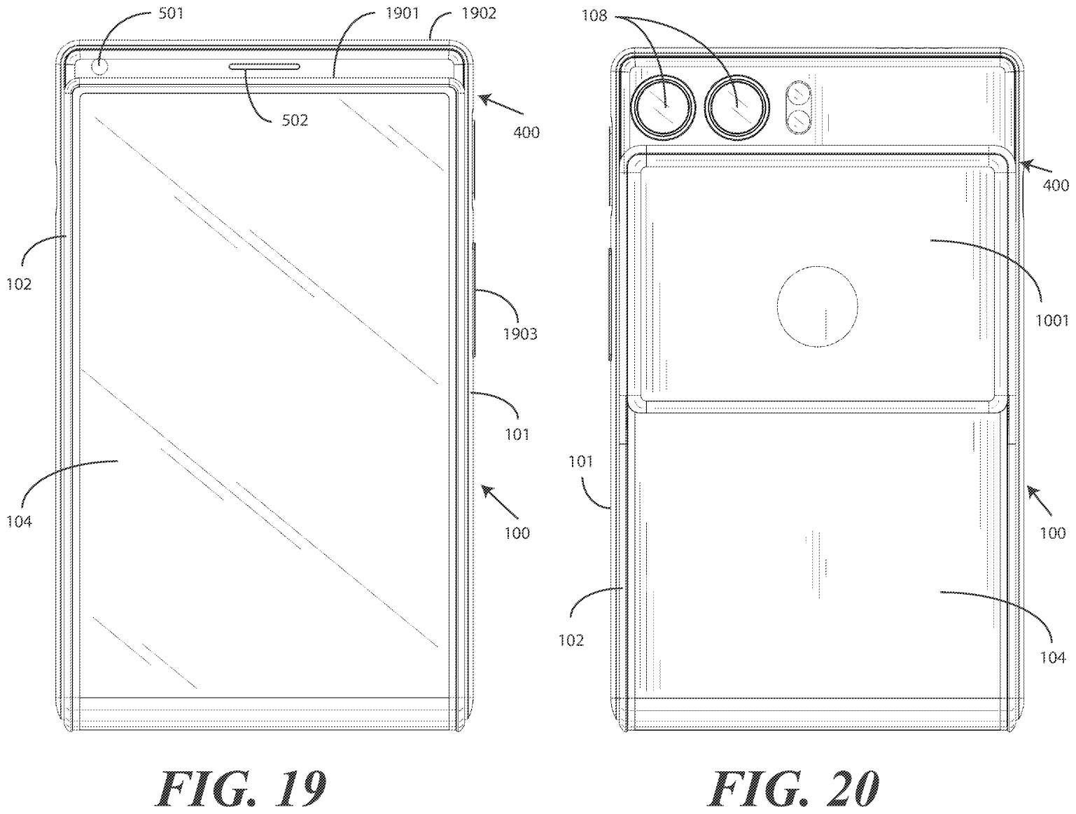

While much attention to this point has been paid to the unique translation of the blade assembly and flexible display between the extended position and the retracted position, one of the other truly unique features offered by embodiments of the disclosure occur when the blade assembly and flexible display transition to the peek position. Turning now to FIGS. 19-20, illustrated therein is the electronic device 100 in this peek position 400.

As shown in FIG. 19, in one or more embodiments when the blade assembly 102 and flexible display 104 transition to the peek position 500, the backpack 1001 moves toward beyond the retracted position (300) toward the rear-facing image capture devices 108. When this occurs, an upper edge 1901 of the blade assembly 102 moves below an upper edge 1902 of the single device housing 101. In one or more embodiments, this reveals a front-facing image capture device 501 that situates beneath the blade assembly 102 when the blade assembly 102 is in the retracted position (300).

In one or more embodiments, the translation of the blade assembly 102 and flexible display 104 to the peek position 500 occurs automatically. Illustrating by example, in one or more embodiments when the front-facing image capture device 501 is actuated, the one or more processors (114) of the electronic device 100 cause the blade assembly 102 to translate to the peek position 500, thereby revealing this image capture device 501. (In the explanatory embodiment of FIGS. 19-20, a loudspeaker 502 is also revealed.) Once image capture operations utilizing the image capture device 501 are complete, the one or more processors (114) can cause the blade assembly 102 to transition back to the retracted position, which again covers and occludes the image capture device 501.

In other embodiments, the transition to the peek position 500 is manually initiated through actuation of a button or other user interface control. Illustrating by example, a single press of the button 1903 might cause the blade assembly 102 to transition to the extended position (200), while a double press of the button 1903 causes the blade assembly 102 to return to the retracted position (300). A long press of the button 1903 may cause the blade assembly 102 to transition to the peek position 500 of FIG. 5, and so forth. Other button operation schema will be obvious to those of ordinary skill in the art having the benefit of this disclosure. In other embodiments, delivery of user input to the flexible display 104 in the form of a pinch gesture can be used to cause the transition to the peek position 500 as well.

By positioning the front-facing image capture device 501 beneath the blade assembly 102 and its corresponding opaque blade (126) when in normal operation, embodiments of the disclosure provide a privacy guarantee to users of the electronic device 100. Said differently, by positioning the image capture device 501 beneath the blade assembly 102 and the flexible display 104 when these components are in either the retracted position (300) or the extended position (200), a user of the electronic device 100 is mechanically assured of privacy due to the fact that it is physically impossible for the image capture device 501 to perform image capture operations through the blade (126) of the blade assembly 102.

Accordingly, even if the electronic device 100 is accessed by a hacker or other nefarious actor, the user can be assured that the image capture device 501 cannot capture images or videos while the blade assembly 102 and flexible display 104 are in the retracted position (300), the extended position (200), or in positions therebetween. Only when the blade assembly 102 and the flexible display 104 transition to the peek position 500, thereby revealing the image capture device 501, can the image capture device 501 capture front-facing images or front-facing videos.

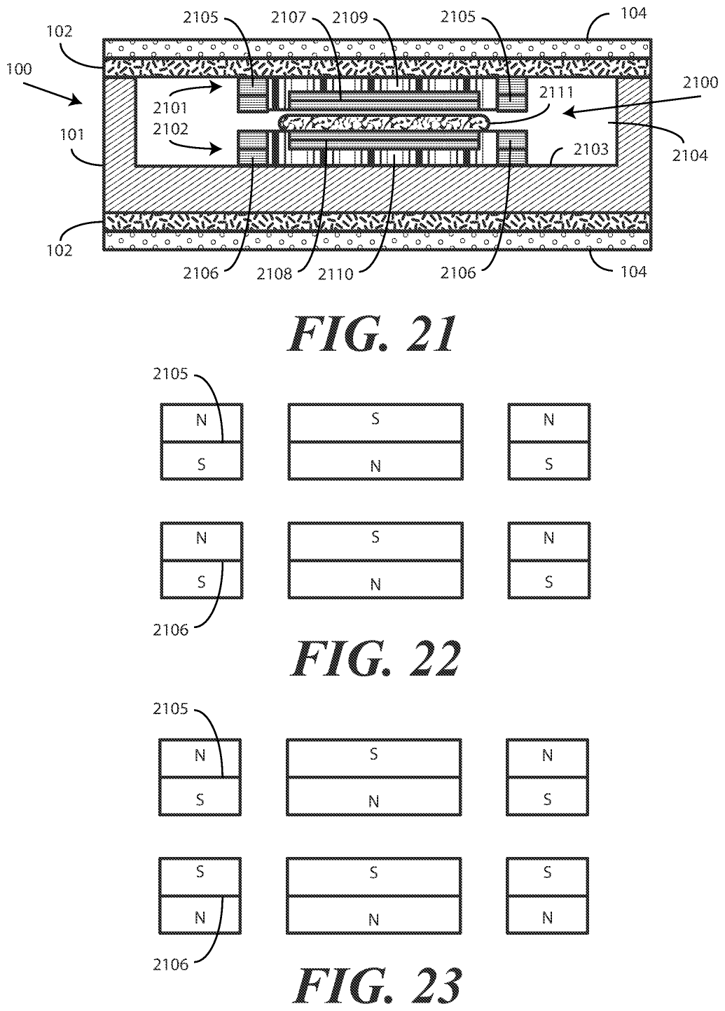

Turning now to FIG. 21, illustrates therein is one explanatory audio output device 2100 in accordance with one or more embodiments of the disclosure. The audio output device 2100 is shown situated in a sectional representation of the electronic device 100 of FIG. 1, which includes the device housing 101 and blade assembly 102 that wraps around an end of the device housing 101 as previously described. In this illustrative embodiment, the blade assembly 102 supports a flexible display.

As shown in FIG. 21, a first audio output device component 2101 is coupled to the blade assembly 102, while a second audio output device component 2102 is coupled to a surface 2103 supported by the device housing 101. In the illustrative embodiment of FIG. 21, the audio output device 2100 is situated within a cavity 2104 defined by the device housing 101 and blade assembly 102.

In one or more embodiments, the first audio output device component 2101 comprises a first permanent magnet 2105, while the second audio output device component 22102 comprises a second permanent magnet 2106. In one or more embodiments, the first permanent magnet 2105 is coupled to the blade assembly 102, while the second permanent magnet 2106 is mechanically coupled to the surface 2103 carried by the device housing 101.

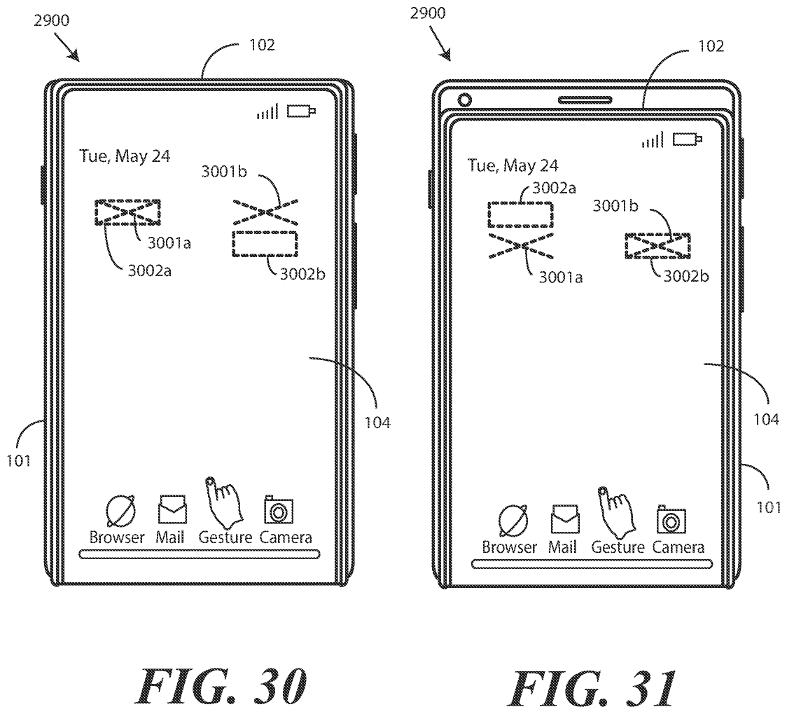

It should be noted that while a first permanent magnet 2105 and a second permanent magnet 2106 are shown, the number of permanent magnets included in the electronic device 100 is not necessarily limited to two. To wit, in this illustrative embodiment the first audio output device component 2101 also comprises a third permanent magnet 2107, while the second audio output device component 2102 comprises a fourth permanent magnet 2108. Moreover, in other embodiments, one example of which is illustrated and described below with reference to FIGS. 30-31, additional permanent magnets are included at different locations. Other configurations will be obvious to those of ordinary skill in the art having the benefit of this disclosure.

In the illustrative embodiment of FIG. 21, the third permanent magnet 2107 and fourth permanent magnet 2108 are generate a force applied by one against the other biases the third permanent magnet 2107 away from the fourth permanent magnet 2108. At the same time, the first permanent magnet 2105 and the second permanent magnet 2106 are configured such that another force applied by one against the other biases the first permanent magnet 2105 and second permanent magnet 2106 toward each other. Thus, the net force applied to the blade assembly 102 may be sum of these two pushing and pulling forces. It should be noted that the forces may be arranged other way around in other embodiments, e.g., where the third permanent magnet 2107 and fourth permanent magnet 2108 pull each other and the first permanent magnet 2105 and the second permanent magnet 2106 push each other. An air gap exists between the first audio output device component 2101 and the second audio output device component 2102.

In one or more embodiments, a first magnetic material 2109 is positioned between the third permanent magnet 2107 and the blade assembly 102, while a second magnetic material 2110 is positioned between the fourth permanent magnet 2108 and the surface 2103 carried by the device housing 101. As shown in FIG. 21, the first magnetic material 2109 is mechanically coupled to the blade assembly 102, while the second magnetic material 2110 is mechanically coupled to the surface 2103 carried by the device housing 101.

In one or more embodiments, this magnetic material 2109,2110 is referred to as a “frame.” Thus, in the embodiments of FIG. 21, the third permanent magnet 2107 is situated in a first frame that is mechanically coupled to the blade assembly 102, while the fourth permanent magnet 2108 is situated in a second frame mechanically coupled to the surface 2103 carried by the device housing 101.

In one or more embodiments, the first magnetic material 2109 and the second magnetic material 2110 function as a buffer between the first permanent magnet 2105 and the second permanent magnet 2106 and the third permanent magnet 2107 and fourth permanent magnet 2110, respectively. As used herein, a “buffer” is a material that reduces magnetic interaction by defining a gap between the permanent magnets. In some embodiments, there may be no need for the gap(s), and thus smaller devices may be achieved. In one or more embodiments, the first magnetic material 2109 and the second magnetic material 2110 are manufactured from a ferromagnetic and/or ferrimagnetic material(s), such as iron.

In one or more embodiments, the first magnetic material 2109 and the second magnetic material 2110 also comprise a core of an axially magnetized permanent ring magnet comprised in the first audio output device component 2101 and/or the second audio output device component 2102. For example, the first magnetic material 2109 may form the core of an axially magnetized permanent ring magnet defined by the first permanent magnet 2105, while the second magnetic material 2110 defined by the second permanent magnet 2106, and so forth.

In the illustrative embodiment of FIG. 21, the first magnetic material 2109 and the second magnetic material 2110 each define a recess into which the third permanent magnet 2107 and the fourth permanent magnet 2108 seat, respectively.

In one or more embodiments, the audio output device 2100 further comprises a coil 2111. In one or more embodiments, the coil 2111 is coupled to an audio output device such as an acoustic driver of the voice engine (122) or an audio driver of the other components (124) of the electronic device 100. In one or more embodiments, the coil 2111 is responsive to electrical signals from the acoustic driver of the voice engine (122) or an audio driver of the other components (124) of the electronic device 100 to generate a magnetic field as a function of the electrical signal. In the illustrative embodiment of FIG. 21, the coil 2111 extends to the area of the first magnetic material 2109 and the second magnetic material 2110. However, in other embodiments this may not be necessary.

Turning now to FIGS. 22 and 23, illustrated therein are examples of different arrangements of the permanent magnets and/or magnetic objects described above with reference to FIG. 21. Illustrating by example, with reference to FIG. 22, if the north poles of the first permanent magnet 2105 and second permanent magnet 2106 are placed to face each other, first permanent magnet 2105 and second permanent magnet 2106 may be arranged such that other provides a south pole and the other provides a north pole that are facing each other. Accordingly, the first force and the second force may be to opposite directions. By contrast, in FIG. 23 the second permanent magnet 2106 is flipped over. This causes a pulling force between the first permanent magnet 2105 and the second permanent magnet 2106. As such, it may be necessary to arrange at least one of the first permanent magnet 2105 or second permanent magnet 2106 to achieve the opposing force therebetween.

While permanent magnets work well in practice for the audio output device (2100) of FIG. 21, it should be noted that the use of permanent magnets may not be necessary in all cases. In other embodiments, the first permanent magnet 2105 and second permanent magnet 2106 may be made of and/or be magnetic material, such as ferromagnetic and/or ferrimagnetic material. Other configurations are described in US Published Patent Application No. 2020/0260189 to Soronen et al., which is incorporated herein by reference for all purposes.

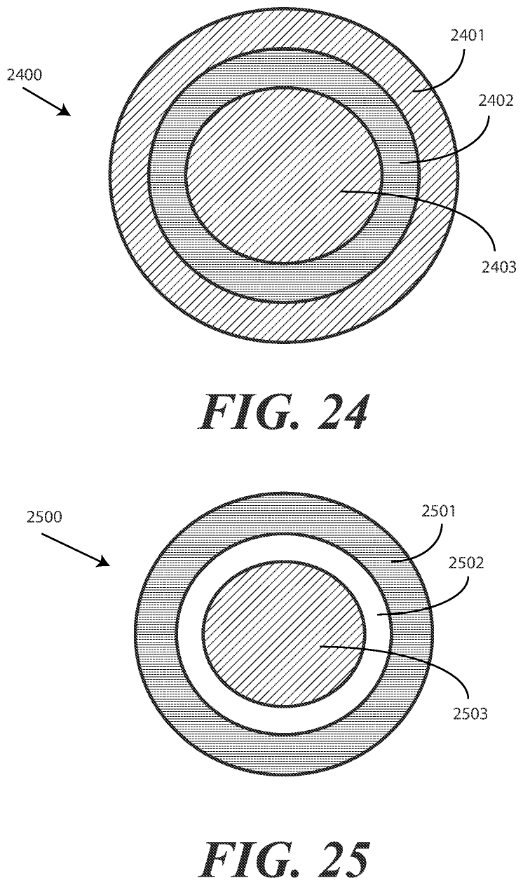

Turning now to FIGS. 24-25, illustrated therein are plan views of additional audio output device components 2400,2500 that can be used in accordance with embodiments of the disclosure. Beginning with FIG. 24, in this illustrative embodiment a magnetic object 2401 encircles a permanent magnet 2403. Note that noted that the encircling magnetic object 2401 may be fully or partially magnetic.

In one or more embodiments, the magnetic object 2401 comprises an axially magnetized permanent ring magnet. That is, the ring magnet may encircle the permanent magnet 2403. Another magnetic element 2402 may be placed between the magnetic object 2401 and the permanent magnet 2403. This other magnetic element 2402 can define a core of the axially magnetized permanent ring magnet defining magnetic object 2401. The element may further comprise a cavity or a slot for the permanent magnet 2403. Thus, the permanent magnet 2403 may be embedded into the other magnetic element 2402, and the other magnetic element 2402 may be embedded into the ring magnet defining magnetic object 2401.

Turning now to FIG. 25, in this embodiment the permanent magnet 2503 may be encircled by a ferromagnetic element 2501 that can be magnetized by the permanent magnet 2503. There may be a gap 2502 between the permanent magnet 2503 and the ferromagnetic element 2501. In one or more embodiments, the gap 2502 enables the permanent magnet 2503 to be in contact with the ferromagnetic element 2501 via only one pole of the permanent magnet 2503.

Referring collectively to FIGS. 24-25, in one or more embodiments the permanent magnet 2403,2503 is a disc magnet. Said differently, in one or more embodiments permanent magnet 2403,2503 is an axially magnetized permanent disc magnet.

Illustrating by example, in one or more embodiments magnetic element 2402 may be a cylinder with a cylindrical cavity, wherein the disc magnet defining permanent magnet 2403 is situated within this cylindrical cavity. While circular in some embodiments, in other embodiments the cavity is rectangular with the permanent magnet 2403 being rectangular as well. Each of audio output device component 2400 and audio output device component 2500 can include a coil (2111) coupled to the permanent magnet 2403,2503 that is energized with an electrical audio signal, thereby causing displacement between the audio output device component 2400,2500 and another audio output device axially situated above the audio output device component 2400,2500 as described above with reference to FIG. 21. When this occurs, the displacement delivers acoustic energy to an environment of the electronic device in which the audio output device component 2400,2500 is situated.

Regardless of configuration, in one or more embodiments the audio output device component (2100),2400,2500 is designed to generate vibration, examples of which include haptic output and/or or audio output. When one audio output device component is axially aligned with another audio output device component, and includes a coil (2111), electrical audio signals delivered to the coil can displace one audio output device component from the other. When configured as shown in FIG. 21, this in effect allows the blade assembly (102) to serve as an acoustic driver to deliver acoustic energy to an environment of the electronic device (100).

As noted above, audio output device components in accordance with embodiments of the disclosure may further comprise a coil (2111) arranged between axially aligned audio output device components. When that coil (2111) is coupled to a signal port of, for example, the voice engine (122) of FIG. 1, an electrical signal is configured to travel between the signal port and the coil (2111). A magnetic field between the first audio output device component (2101) and the second audio output device component (2102) causes a force to act between the first audio output device component (2101) and the second audio output device component (2102). Since the blade assembly (102) defines a somewhat elastic element relative to the device housing (101) providing a supporting counterforce to the force caused by the magnetic field, the electrical signal in the coil (2111) causes mechanical displacement of the blade assembly (102). This causes the blade assembly (102) to vibrate according to the electrical input signal, thereby delivering acoustic energy to an environment of an electronic device in which the audio output device is coupled.

As used herein, “audio output” refers to sound that is detectable by human ear, a microphone, or animals. Illustrating by example, the audio output may comprise music, speech, sound effects, and so forth.

Turning now to FIGS. 26-27, illustrated therein is the electronic device 100 of FIG. 1 with the flexible display 104 in the retracted position. Audio output device components are shown either coupled to the blade assembly 102 or to a surface (2103) carried by the device housing 101. In this illustrative embodiment, there are two audio output device components equivalent to audio output device component (2101) from FIG. 21. Each is mechanically coupled to the blade assembly 102 and is represented by a plus sign. Moreover, the electronic device 100 comprises one audio output device component equivalent to audio output device component (2102) from FIG. 21. It is mechanically coupled to a surface (2103) carried by the device housing 101.

Thus, in this illustrative embodiment the electronic device 100 comprises a first audio output device component 2101a mechanically coupled to the blade assembly 102 and a second audio output device component 2102 mechanically coupled to a surface (2103) carried by the device housing. However, the electronic device 100 also comprises a third audio output device component 2101b that is also mechanically coupled to the blade assembly 102.

In this illustrative embodiment, each audio output device component 2101a,2101b,2102 comprises a permanent magnet. Thus, the electronic device comprises a first permanent magnet mechanically coupled to the blade assembly 102, a second permanent magnet mechanically coupled to a surface (2103) carried by the device housing 101, and a third permanent magnet mechanically coupled to the blade assembly 102 at a location different from the first permanent magnet. As noted above, in other embodiments magnetic materials other than permanent magnets will be used in each audio output device component 2101a,2101b,2102.

As noted above, a translation mechanism (105) operable to slide the blade assembly 102 relative to the device housing between an extended position and retracted position has moved the blade assembly 102 to the retracted position in FIG. 26. As shown in this figure, when the blade assembly 102 is in the retracted position, the first audio output device component 2101a and the second audio output device component 2102 axially align (along an axis normal to the page). Thus, these two audio output device components 2101a,2102 define an audio output device. At the same time, the second audio output device component 2102 and the third audio output device component 2101b axially misalign.

When the voice engine (122) or another audio output device delivers an electrical signal to a coil (2111) coupled to and operable with the second audio output device component 2102, the coil (2111) generates a magnetic field as a function of the electrical signal. This causes displacement between the equilibrium positions of the first audio output device component 2101a and the second audio output device component 2102, thereby driving the blade assembly 102 to deliver acoustic energy to the environment of the electronic device 100.

Turning now to FIG. 27, in this figure the translation mechanism (105) has moved the blade assembly 102 to the extended position. As shown in this figure, when this occurs this causes the second audio output device component 2102 and the third audio output device component 2101b to axially align, thereby defining another audio output device. At the same time, the first audio output device component 2101a and the second audio output device component 2102 axially misalign.

When the voice engine (122) or another audio output device delivers an electrical signal to a coil (2111) coupled to and operable with the second audio output device component 2102, the coil (2111) generates a magnetic field as a function of the electrical signal. This causes displacement between the equilibrium positions of the third audio output device component 2101b and the second audio output device component 2102, thereby again driving the blade assembly 102 to deliver acoustic energy to the environment of the electronic device 100.

Advantageously, this arrangement of the audio output device components 2101a,2101b,2102 allows a single lower audio output device component 2102 to work with two upper audio output device components 2101a,2101b to create a functioning audio output device operable to use the blade assembly 102 as a driver to deliver acoustic energy to the environment of the electronic device 100. Said differently, the magnetic field generated by the coil (2111) coupled to the second audio output device component 2102 displaces the blade assembly 102 relative to the surface (2103) carried by the device housing 101 to deliver acoustic energy to an environment of the electronic device 100 when the blade assembly 102 is either in the retracted position of FIG. 26 or the extended position of FIG. 27.

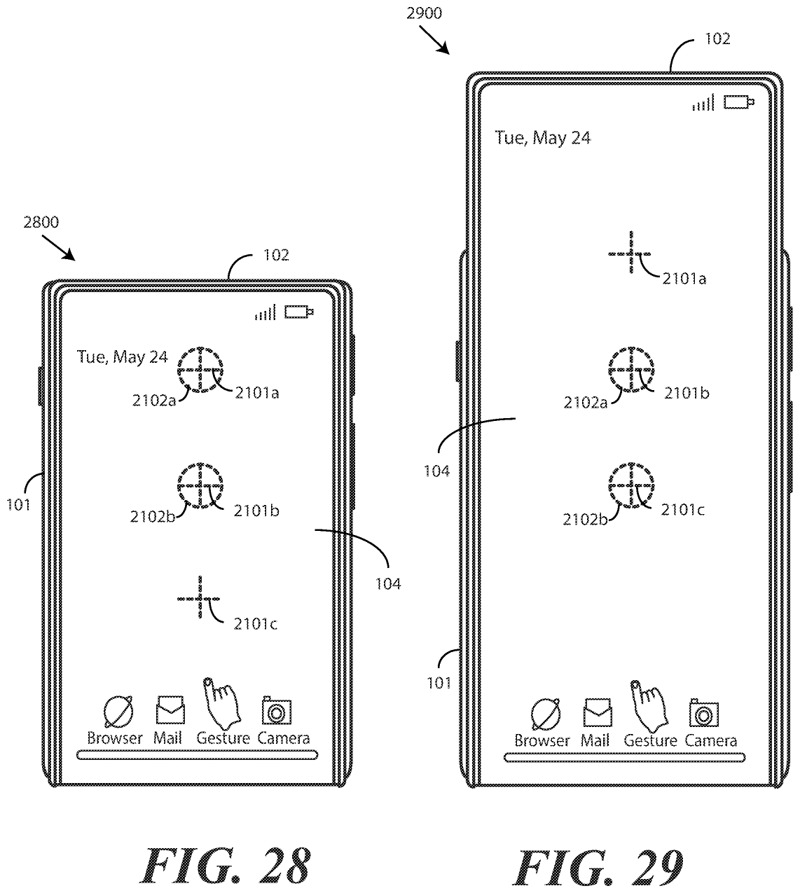

Turning now to FIGS. 28-29, illustrated therein is another electronic device 2800 that demonstrate how embodiments of the disclosure can be expanded. Like the electronic device (100) of FIG. 27, the electronic device 2800 of FIG. 28 comprises a first audio output device component 2101a mechanically coupled to the blade assembly 102 and a second audio output device component 2102a mechanically coupled to a surface (2103) carried by the device housing 101. In this illustrative embodiment, the electronic device 100 also comprises a third audio output device component 2101b and a fourth audio output device component 2101c that are both mechanically coupled to the blade assembly 102. Moreover, a fifth audio output device component 2102b is mechanically coupled to the surface (2103) carried by the device housing 101.

As before, each audio output device component 2101a,2101b,2101c,2102a,2102b comprises a permanent magnet. These permanent magnets could be situated within frames. In other embodiments magnetic materials other than permanent magnets will be used in each audio output device component 2101a,2101b,2101c,2102a,2102b.

As noted above, a translation mechanism (105) operable to slide the blade assembly 102 relative to the device housing between an extended position and retracted position has moved the blade assembly 102 to the retracted position in FIG. 28. As shown in this figure, when the blade assembly 102 is in the retracted position, two audio output devices are created. To wit, when the blade assembly 102 is in the retracted position, the first audio output device component 2101a, and the second audio output device component 2102a axially align to define a first audio output device. Similarly, the third audio output device component 2101b and the fifth audio output device component 2102b axially align to define a second audio output device. Meanwhile, the fourth audio output device component 2101c axially misaligns with either the second audio output device component 2102a or the fifth audio output device component 2102b.

When the voice engine (122) or another audio output device delivers an electrical signal to coil (similar to coil 2111 of FIG. 21) coupled to and operable with the second audio output device component 2102a and the fifth audio output device component 2102b, the coils generate magnetic fields as a function of the electrical signal. This causes displacement between the equilibrium positions of the first audio output device component 2101a and the second audio output device component 2102a, and further between the third audio output device component 2101b and the fifth audio output device component 2102b, thereby driving the blade assembly 102 to deliver acoustic energy to the environment of the electronic device 100.

Turning now to FIG. 29, in this figure the translation mechanism (105) has moved the blade assembly 102 to the extended position. As shown in this figure, when this occurs this causes the third audio output device component 2101b to axially align with the second audio output device component 2102a, while the fourth audio output device component 2101c axially aligns with the fifth audio output device component 2102b. The first audio output device component 2101 becomes axially misaligned with either the second audio output device component 2102a or the fifth audio output device component 2102b.

However, the axially align between the third audio output device component 2101b and second audio output device component 2102a, and fourth audio output device component 2101c and fifth audio output device component 2102b, defines two other audio output devices. When the voice engine (122) or another audio output device delivers an electrical signal to a coil associated with these two other audio output devices, magnetic fields cause displacement between the equilibrium positions, thereby again driving the blade assembly 102 to deliver acoustic energy to the environment of the electronic device 100.

Recall from above that in one or more embodiments the translation mechanism (105) is further operable to translate the blade assembly 102 to a peek position. Embodiments of the disclosure contemplate that even minor axial misalignments between upper audio output device component and lower audio output device component can cause the combined audio output device component to struggle to deliver the acoustic energy to the environment of the electronic device 2800. However, additional audio output device components can be included to allow the tunes to continue to flow even when the blade assembly 102 is in the peek position. Turning now to FIGS. 30-31, illustrated therein is one explanatory electronic device 2900 demonstrating how this can occur. Other configurations allowing axially align of audio output device components in the peek position will be obvious to those of ordinary skill in the art having the benefit of this disclosure.

Illustrated in FIGS. 28-29 is an electronic device 2900 comprising a device housing 101, a blade assembly 102 carrying a blade and a flexible display 104, with the blade assembly 102 being slidably coupled to the device housing 101. A translation mechanism (105) is operable to slide the blade assembly 102 relative to the device housing 101 between an extended position, a retracted position, and a peek position. In FIG. 28, the blade assembly 102 is in the retracted position. However, in FIG. 29 the blade assembly 102 is in the peek position.

Recall from above that while some embodiments of audio output device components are round, they can be rectangular as well. In FIGS. 28-29, the audio output device components are rectangular with upper audio output device components represented by the letter X and lower audio output device components being represented by rectangles.

In this illustrative embodiment, there are four audio output device components 3001a,3001b,3002a,3002b. The upper audio output device components 3001a,3001b are mechanically coupled to the blade assembly 102, while the lower audio output device components 3002a,3002b are mechanically coupled to a surface (2103) carried by the device housing 101. As before, the audio output device components can comprise permanent magnets and can be seated in frames.

As shown in FIG. 30, a first audio output device component 3001a and a second audio output device component 3001b are mechanically coupled to the blade assembly 102. Meanwhile, a third audio output device component 3002a and a fourth audio output device component 3002b are mechanically coupled to the surface (2103) carried by the device housing 101.

The translation mechanism (105) has moved the blade assembly 102 to the retracted position in FIG. 30. As shown in this figure, when the blade assembly 102 is in the retracted position, the first audio output device component 3001a and the third audio output device component 3002a axially align (along an axis normal to the page), thereby defining an audio output device. However, the second audio output device component 3001b and the fourth audio output device component 3002b axially misalign.

When the voice engine (122) or another audio output device delivers an electrical signal to a coil (2111) coupled to and operable with the third audio output device component 3002a, the coil (2111) generates a magnetic field as a function of the electrical signal. This causes displacement between the equilibrium positions of the first audio output device component 3001a and the third audio output device component 3002a, thereby driving the blade assembly 102 to deliver acoustic energy to the environment of the electronic device 100.

Turning now to FIG. 31, in this figure the translation mechanism (105) has moved the blade assembly 102 to the peek position. As shown in this figure, when this occurs this causes the second audio output device component 3001b and the fourth audio output device component 3002b to axially align, thereby defining another audio output device. At the same time, the first audio output device component 3001a and the third audio output device component 3002a axially misalign.

When the voice engine (122) or another audio output device delivers an electrical signal to a coil (2111) coupled to and operable with the fourth audio output device component 3002b, the coil (2111) generates a magnetic field as a function of the electrical signal. This causes displacement between the equilibrium positions of the second audio output device component 3001b and the fourth audio output device component 3002b, thereby again driving the blade assembly 102 to deliver acoustic energy to the environment of the electronic device 100.

Translation of the blade assembly to the extended position would cause axial misalignment between the upper audio output device components 3001a,3001b and the lower audio output device components 3002a,3002b. However, either the embodiment of FIGS. 26-27 or FIGS. 28-29 could be included so that at least one audio output device would be operable regardless of whether the blade assembly 102 was in the extended position, the retracted position, or the peek position.

Advantageously, the embodiments described above provide two-part audio output device components that axially align with an air gap therebetween. This axially align results in two audio output device components being magnetically coupled together, but not physically attached to each other. In one or more embodiments, a lower audio output device component is mechanically coupled to a surface carried by a device housing (one example of which is a printed circuit board), while the upper audio output device component is mechanically coupled to the blade assembly. When multiple, upper audio output device components or alternatively, multiple lower audio output device components, are included translation of the blade assembly relative to the device housing axially align upper and lower audio output device component pairs at predefined locations, examples of which include the extended position, retracted position, and peek position. This axially alignment advantageously defines audio output devices capable of delivering audio output to an environment of the electronic device at these locations to deliver audio output to an environment of the electronic device.

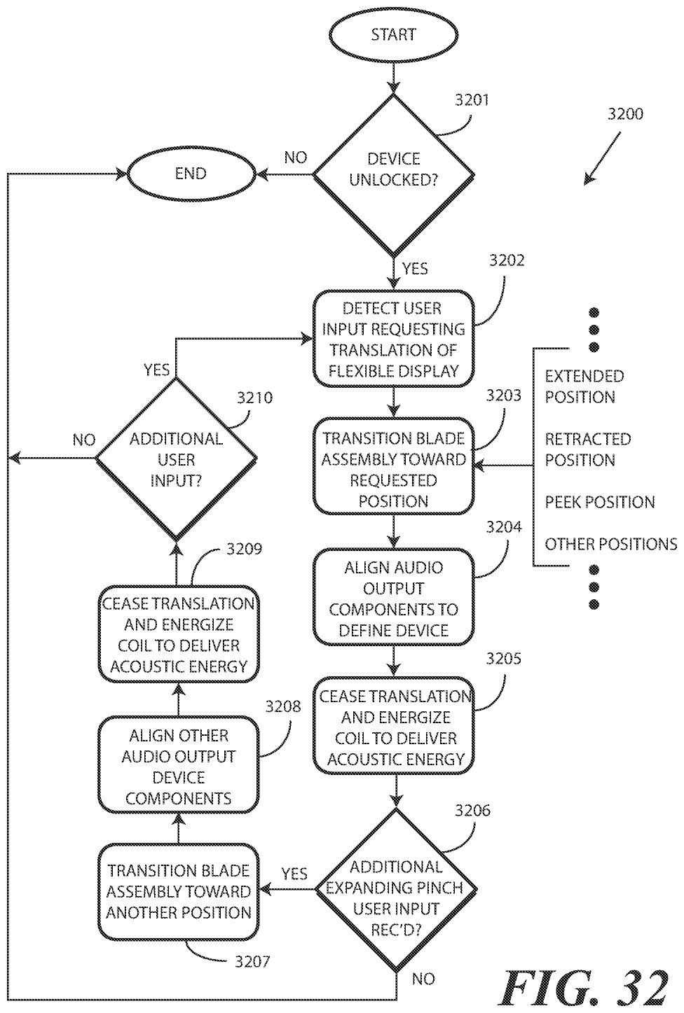

Attention will now be turned to methods for using the electronic devices described above, and more particularly, to movement of the flexible display and blade assembly to axially align audio output device components, optionally comprising permanent magnets, in accordance with one or more embodiments of the disclosure. Turning now to FIG. 32, illustrated therein is one explanatory method 3200 in accordance with one or more embodiments of the disclosure. The method 3200 of FIG. 32 is intended for use in an electronic device having a device housing, a blade assembly carrying a blade and a flexible display, with the blade assembly being slidably coupled to the device housing, a translation mechanism operable to slide the blade assembly relative to the device housing between at least an extended position and a retracted position, and one or more processors operable with the translation mechanism.

Decision 3201 determines whether the electronic device is in a locked state or an unlocked state. In some embodiments it is undesirable to cause translation of a blade assembly coupled to a flexible display in response to user input delivered to that flexible display when the electronic device is in a locked mode of operation. Accordingly, in some embodiments any translating in response to user input occurs only when the electronic device is in an unlocked state, as determined by decision 3201, when the user input is detected.

Step 3202 then comprises detecting, with a flexible display carried by a blade assembly that is slidably coupled to a device housing and movable between at least an extended position and a retracted position, user input. In one or more embodiments, the user input detected at step 3202 comprises a pinch gesture. In other embodiments, the user input detected at step 3202 comprises actuation of a button or other user interface control.

If step 3202 comprises detecting user input directed expanding, step 3203 comprises translating, by a translation mechanism operable with the blade assembly, the blade assembly to a predefined position, examples of which include the extended position, peek position, or retracted position. Step 3204 comprises axially aligning a first audio output device component fixedly positioned within the device housing and a second audio output device component mechanically coupled to the blade assembly. Thus, if step 3203 comprises translating the blade assembly to the extended position, in one or more embodiments this results in step 3204 comprising axially aligning a first audio output device component fixedly positioned within the device housing and a second audio output device component mechanically coupled to the blade assembly to define an operable audio output device.

Step 3205 then comprises ceasing the translation of the blade assembly once the desired position is reached. In one or more embodiments, step 3205 further comprises energizing a coil coupled to the first audio output device component with an electrical signal, thereby causing displacement between the first audio output device component and the second audio output device component. In one or more embodiments, the displacement delivers acoustic energy to an environment of the electronic device.

Step 3205 can comprise other operations as well. Illustrating by example, one or more processors of the electronic device may present, on the flexible display, content on newly exposed front-facing portions of the flexible display that are revealed by the translation occurring at step 3203.

Decision 3206 then determines whether an additional user input is detected. Where it is, step 3207 comprises translating the blade assembly to another position. Step 3208, which results from the translation, comprises causing the first audio output device component and second audio output device component to axially misalign. However, step 3208 comprises causing a third audio output device component mechanically coupled to the blade assembly to axially align with the first audio output device component. Step 3209 can then comprise again energizing the coil with another electrical audio signal, thereby causing other displacement between the first audio output device component and the third audio output device component to deliver other acoustic energy to the environment of the electronic device. The method 3200 can optionally repeat, as determined by decision 3210.

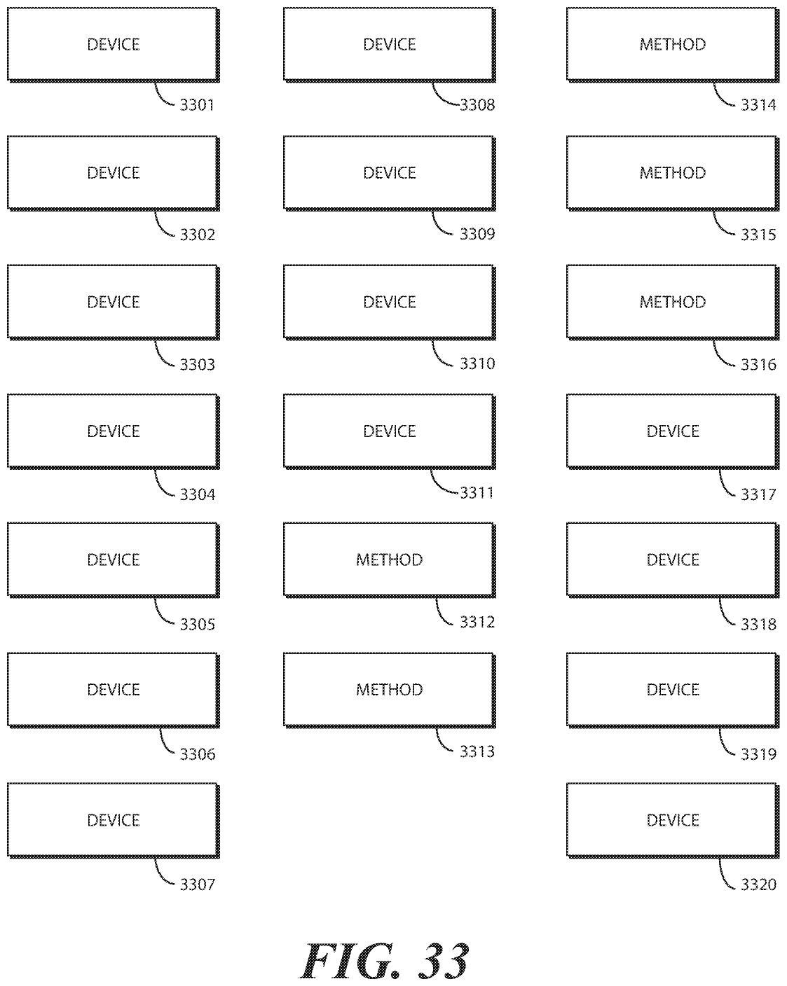

Turning now to FIG. 33, illustrated therein are various embodiments of the disclosure. The embodiments of FIG. 33 are shown as labeled boxes in FIG. 3. 33 due to the fact that the individual components of these embodiments have been illustrated in detail in FIGS. 1-32, which precede FIG. 33. Accordingly, since these items have previously been illustrated and described, their repeated illustration is no longer essential for a proper understanding of these embodiments. Thus, the embodiments are shown as labeled boxes.

At 3301, an electronic device comprises a device housing, a blade assembly carrying a blade and a flexible display and slidably coupled to the device housing, and a translation mechanism operable to slide the blade assembly relative to the device housing between an extended position and a retracted position. At 3301, the electronic device comprises a first audio output device component mechanically coupled to the blade assembly and a second audio output device component mechanically coupled to a surface carried by the device housing. At 3301, translation of the blade assembly to the extended position causes the first audio output device component and the second audio output device component to axially align. At 3302, the translation of the blade assembly of 3201 to the retracted position causes the first audio output device component and the second audio output device component to axially misalign.

At 3303, the electronic device of 3302 further comprises a third audio output device component mechanically coupled to the blade assembly. At 3303, translation of the blade assembly to the retracted position causes the second audio output device component and the third audio output device component to axially align. At 3304, translation of the blade assembly at 3303 to the extended position causes the third audio output device component and the second audio output device component to axially misalign.

At 3305, the translation mechanism of 3304 is further operable to slide the blade assembly relative to the device housing to a peek position revealing an image capture device. At 3306, the electronic device of 3304 further comprises an audio output device and a coil electrically coupled to the audio output device and responsive to an electrical signal from the audio output device to generate a magnetic field as a function of the electrical signal.

At 3307, the second audio output device component of 3306 is situated in a frame that is mechanically coupled to the surface carried by the device housing. At 3307, the magnetic field displaces the blade assembly relative to the surface to deliver acoustic energy to an environment of the electronic device when the blade assembly is either in the retracted position or the extended position.

At 3308, the electronic device of 3304 further comprises a fourth audio output device component mechanically coupled to the blade assembly and a fifth audio output device component mechanically coupled to the surface carried by the device housing. At 3309, translation of the blade assembly of 3308 to the extended position causes the third audio output device component and the fifth audio output device component to axially align and the fourth audio output device component and the fifth audio output device component to axially misalign. At 3310, translation of the blade assembly of 3309 to the retracted position causes the fourth audio output device component and the fifth audio output device component to axially align.

At 3311, an end of the blade assembly of 3301 extends beyond an edge of the device housing when in the extended position and is coextensive with a minor surface of the device housing when in the retracted position.

At 3312, a method in an electronic device comprises translating, with a translation mechanism, a blade assembly that is slidably coupled to a device housing and moveable between an extended position and a retracted position to the extended position. At 3312, the translating thereby axially aligns a first permanent magnet fixedly positioned within the device housing with a second permanent magnet mechanically coupled to the blade assembly.

At 3313, the method of 3312 further comprises energizing a coil coupled to the first permanent magnet with an electrical audio signal, thereby causing displacement between the first permanent magnet and the second permanent magnet, the displacement delivering acoustic energy to an environment of the electronic device. At 3314, the method of 3313 further comprises translating, with the translation mechanism, the blade assembly to the retracted position to cause the first permanent magnet and the second permanent magnet to axially misalign.

At 3315, the translating of the blade assembly of 3314 to the retracted position causes a third permanent magnet mechanically coupled to the blade assembly to axially align with the first permanent magnet. At 3316, the method of 3315 further comprises again energizing the coil with another electrical audio signal, thereby causing other displacement between the first permanent magnet and the third permanent magnet, the other displacement delivering other acoustic energy to the environment of the electronic device.

At 3317, an electronic device comprises a device housing, a blade assembly carrying a blade and a flexible display and slidably coupled to the device housing, and a translation mechanism operable to slide the blade assembly relative to the device housing between an extended position, a retracted position, and a peek position. At 3317, the electronic device comprises a first audio output device component mechanically coupled to the blade assembly and a second audio output device component mechanically coupled to a surface carried by the device housing. At 3317, translation of the blade assembly to the peek position causes the first audio output device component and the second audio output device component to axially align.

At 3318, translation of the blade assembly of 3317 to the extended position or retracted position causes axial misalignment between the first audio output device component and the second audio output device component.

At 3319, the electronic device of 3318 further comprises a third audio output device component mechanically coupled to the blade assembly and a fourth audio output device component mechanically coupled to the surface. At 3320, translation of the blade assembly of 3319 to the retracted position causes the third audio output device component and the fourth audio output device component to axially align.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. An electronic device, comprising:
a device housing;
a blade assembly carrying a blade and a flexible display and slidably coupled to the device housing;
a translation mechanism operable to slide the blade assembly relative to the device housing between an extended position and a retracted position;
a first audio output device component mechanically coupled to the blade assembly; and
a second audio output device component mechanically coupled to a surface carried by the device housing;
wherein translation of the blade assembly to the extended position causes the first audio output device component and the second audio output device component to axially align.

2. The electronic device of claim 1, wherein translation of the blade assembly to the retracted position causes the first audio output device component and the second audio output device component to axially misalign.

3. The electronic device of claim 2, further comprising a third audio output device component mechanically coupled to the blade assembly, wherein translation of the blade assembly to the retracted position causes the second audio output device component and the third audio output device component to axially align.

4. The electronic device of claim 3, wherein translation of the blade assembly to the extended position causes the third audio output device component and the second audio output device component to axially misalign.

5. The electronic device of claim 4, wherein the translation mechanism is further operable to slide the blade assembly relative to the device housing to a peek position revealing an image capture device.

6. The electronic device of claim 4, further comprising an audio output device and a coil electrically coupled to the audio output device and responsive to an electrical signal from the audio output device to generate a magnetic field as a function of the electrical signal.

7. The electronic device of claim 6, wherein:
the second audio output device component is situated in a frame that is mechanically coupled to the surface carried by the device housing; and
the magnetic field displaces the blade assembly relative to the surface to deliver acoustic energy to an environment of the electronic device when the blade assembly is either in the retracted position or the extended position.

8. The electronic device of claim 4, further comprising:
a fourth audio output device component mechanically coupled to the blade assembly; and
a fifth audio output device component mechanically coupled to the surface carried by the device housing.

9. The electronic device of claim 8, wherein translation of the blade assembly to the extended position causes:
the third audio output device component and the fifth audio output device component to axially align; and
the fourth audio output device component and the fifth audio output device component to axially misalign.

10. The electronic device of claim 9, wherein translation of the blade assembly to the retracted position causes the fourth audio output device component and the fifth audio output device component to axially align.

11. The electronic device of claim 1, wherein and end of the blade assembly extends beyond an edge of the device housing when in the extended position and is coextensive with a minor surface of the device housing when in the retracted position.

12. A method in an electronic device, the method comprising translating, with a translation mechanism, a blade assembly that is slidably coupled to a device housing and moveable between an extended position and a retracted position to the extended position, thereby axially aligning a first permanent magnet fixedly positioned within the device housing with a second permanent magnet mechanically coupled to the blade assembly.

13. The method of claim 12, further comprising energizing a coil coupled to the first permanent magnet with an electrical audio signal, thereby causing displacement between the first permanent magnet and the second permanent magnet, the displacement delivering acoustic energy to an environment of the electronic device.

14. The method of claim 13, further comprising translating, with the translation mechanism, the blade assembly to the retracted position to cause the first permanent magnet and the second permanent magnet to axially misalign.

15. The method of claim 14, wherein the translating the blade assembly to the retracted position causes a third permanent magnet mechanically coupled to the blade assembly to axially align with the first permanent magnet.

16. The method of claim 15, further comprising again energizing the coil with another electrical audio signal, thereby causing other displacement between the first permanent magnet and the third permanent magnet, the other displacement delivering other acoustic energy to the environment of the electronic device.

17. An electronic device, comprising:
a device housing;
a blade assembly carrying a blade and a flexible display and slidably coupled to the device housing;
a translation mechanism operable to slide the blade assembly relative to the device housing between an extended position, a retracted position, and a peek position;
a first audio output device component mechanically coupled to the blade assembly; and
a second audio output device component mechanically coupled to a surface carried by the device housing;
wherein translation of the blade assembly to the peek position causes the first audio output device component and the second audio output device component to axially align.

18. The electronic device of claim 17, wherein translation of the blade assembly to the extended position or retracted position causes axial misalignment between the first audio output device component and the second audio output device component.

19. The electronic device of claim 18, further comprising:
a third audio output device component mechanically coupled to the blade assembly; and
a fourth audio output device component mechanically coupled to the surface.

20. The electronic device of claim 19, wherein translation of the blade assembly to the retracted position causes the third audio output device component and the fourth audio output device component to axially align.
